(19) United States
(12) Patent Application Publication
(10) Pub. No.: US 2024/0166778 A1
(43) Pub. Date: May 23, 2024

(54) METHOD FOR PRODUCING POLYMER AND POLYMER

(71) Applicant: TOKYO OHKA KOGYO CO., LTD., Kawasaki-shi (JP)

(72) Inventor: Takuya Uehara, Kawasaki-shi (JP)

(21) Appl. No.: 18/491,256

(22) Filed: Oct. 20, 2023

(30) Foreign Application Priority Data
Oct. 27, 2022 (JP) 2022-172168

(51) Int. Cl. C08F 20/06; C08F 8/34

(52) U.S. Cl. CPC C08F 20/06; C08F 8/34; C08F 2438/03

(57) ABSTRACT

A method for producing a polymer, including reacting a polymer (P1) having a structure represented by General Formula (t1-1) at a terminal of a main chain with a nucleophilic agent in which a pKa of a conjugate acid is 11 or less to obtain a polymer (P2) having a structure represented by Formula (t2-1) at a terminal of a main chain. In formula (t1-1), Z represents a monovalent organic group, and in both formulas, * represents a bonding site bonded to a carbon atom which constitutes a main chain of an adjacent constitutional unit

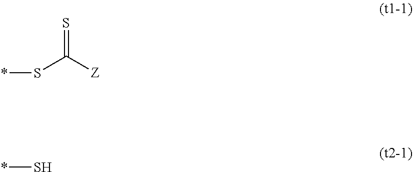

### BACKGROUND OF THE INVENTION

### Field of the Invention

The present invention relates to a method for producing a polymer and a polymer.

Priority is claimed on Japanese Patent Application No. 2022-172168, filed on Oct. 27, 2022, the content of which is incorporated herein by reference.

### Description of Related Art

In a polymer having a thiol group at a terminal of a main chain, various functional groups can be introduced into the terminal of the main chain by a thiol-yen reaction. Accordingly, the polymer having a thiol group at the terminal of the main chain is useful as an intermediate for a functional polymer.

As a method for producing the polymer having a thiol group at the terminal of the main chain, a method for producing the polymer by RAFT polymerization is an exemplary example. In the RAFT polymerization, radical polymerization is performed in the presence of a RAFT agent such as a thiocarbonyl compound to form a polymer having a dithioester structure at the terminal of the main chain. By converting this dithioester structure into a thiol group by aminolysis, it is possible to obtain a polymer having a thiol group at the terminal of the main chain.

For example, Japanese Unexamined Patent Application, First Publication No. 2002-265508 discloses a method of treating a polymer obtained by the RAFT polymerization with a hindered amine compound to obtain the polymer having a thiol group at the terminal of the main chain.

### SUMMARY OF THE INVENTION

### Problems to be Solved by Invention

During the aminolysis reaction of the dithioester structure at the terminal of the main chain of the polymer, the generated thiol group may react with adjacent constitutional units to form a thiolactone ring. Since the thiolactone ring has low reactivity, it is difficult to introduce a functional group into the thiolactone ring. Therefore, in order to efficiently obtain a polymer into which a desired functional group is introduced, it is required to suppress the formation of the thiolactone ring by the subsequent reaction.

The present invention has been made in consideration of the above-described circumstances, and an object of the present invention is to provide a method for producing a polymer, in which a formation of a thiolactone ring can be suppressed in a case of carrying out a reaction of converting a dithioester structure at a terminal of a main chain of a polymer into a thiol group, and a polymer produced by the production method.

### Means for Solving Problems

In order to solve the above-described problem, the present invention employs the following configurations.

That is, a first aspect of the present invention is a method for producing a polymer, including a step of reacting a polymer (P1) having a structure represented by General Formula (t1-1) at a terminal of a main chain with a nucleophilic agent in which a pKa of a conjugate acid is 11 or less to obtain a polymer (P2) having a structure represented by Formula (t2-1) at a terminal of a main chain.

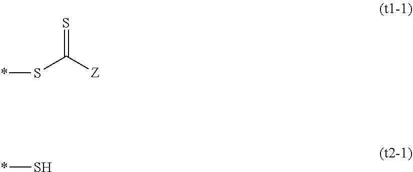

[in General Formula (t1-1), Z represents a monovalent organic group; and * represents a bonding site bonded to a carbon atom which constitutes a main chain of an adjacent constitutional unit,

in General Formula (t2-1), * represents a bonding site bonded to a carbon atom which constitutes a main chain of an adjacent constitutional unit]

A second aspect of the present invention is a method for producing a polymer, including a step (i) of obtaining the polymer (P2) by the method for producing a polymer according to the first aspect and a step (ii) of reacting the polymer (P2) with a compound (A1) represented by General Formula (a1-1) to obtain a polymer (P3) having a structure represented by General Formula (t3-1) at a terminal of a main chain.

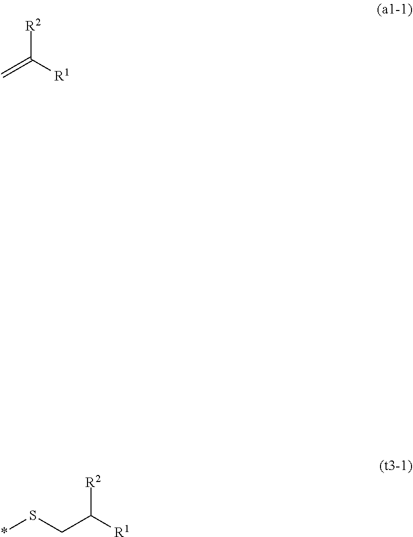

[in the formula, R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit]

A third aspect of the present invention is a polymer having a structure represented by Formula (t2-1) at a terminal of a main chain, in which no peak at 210 ppm is detected in a spectrum measured by ¹³C-NMR in deuterated acetone at 40° C.

*—SH (t2-1)

[in the formula, * represents a bonding site bonded to a carbon atom which constitutes a main chain of an adjacent constitutional unit]

A fourth aspect of the present invention is a polymer having a structure represented by Formula (t3-1) at a terminal of a main chain, in which no peak at 210 ppm is detected in a spectrum measured by ¹³C-NMR in deuterated acetone at 40° C.

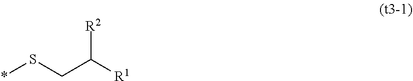

[in the formula, R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit]

### Effect of Invention

According to the present invention, it is possible to provide a method for producing a polymer, in which a formation of a thiolactone ring can be suppressed in a case of carrying out a reaction of converting a dithioester structure at a terminal of a main chain of a polymer into a thiol group, and a polymer produced by the production method.

### DETAILED DESCRIPTION OF THE INVENTION

In the present specification and the scope of the present claims, the term “aliphatic” is a relative concept used with respect to “aromatic” and defines a group or compound that has no aromaticity.

A term “alkyl group” includes linear, branched, or cyclic monovalent saturated hydrocarbon groups unless otherwise specified.

A term “alkylene group” includes linear, branched, or cyclic divalent saturated hydrocarbon groups unless otherwise specified. The same applies to an alkyl group in an alkoxy group.

As a term “halogen atom” a fluorine atom, a chlorine atom, a bromine atom, and an iodine atom are exemplary examples.

A “halogenated alkyl group” is a group in which a part of or all of hydrogen atoms in an alkyl group are substituted with halogen atoms. As the halogen atom, a fluorine atom, a chlorine atom, a bromine atom, and an iodine atom are exemplary examples.

The “fluorinated alkyl group” or a “fluorinated alkylene group” is a group obtained by substituting part or all of hydrogen atoms of an alkyl group or an alkylene group with a fluorine atom.

A term “constitutional unit” indicates a monomer unit constituting a polymer compound (a resin, a polymer, or a copolymer).

A term “aromatic hydrocarbon group” is a hydrocarbon group having at least one aromatic ring. The aromatic ring is not particularly limited as long as the aromatic ring has a cyclic conjugated system having (4n+2) pieces of π electrons, and may be monocyclic or polycyclic.

A phrase “constitutional unit derived from” means a constitutional unit that is formed by the cleavage of a multiple bond between carbon atoms, for example, an ethylenic double bond.

“(α-substituted) acrylic acid” refers to acrylic acid in which a hydrogen atom bonded to a carbon atom at an α-position may be substituted with a substituent. The (α-substituted) acrylic acid includes acrylic acid, and acrylic acid in which a hydrogen atom bonded to a carbon atom at an α-position is substituted with a substituent. The substituent (R^{αx}) that is substituted for the hydrogen atom bonded to the carbon atom at the α-position is an atom other than a hydrogen atom or a group. The carbon atom at the α-position of acrylic acid indicates the carbon atom bonded to the carbonyl group of acrylic acid unless otherwise specified.

“(α-substituted) acrylic acid ester” refers to acrylic acid ester in which a hydrogen atom bonded to a carbon atom at an α-position may be substituted with a substituent. The “(α-substituted) acrylic acid ester” includes acrylic acid ester, and acrylic acid ester in which a hydrogen atom bonded to a carbon atom at an α-position is substituted with a substituent. The substituent (R^{αx}) that is substituted for the hydrogen atom bonded to the carbon atom at the α-position is an atom other than a hydrogen atom or a group. In addition, itaconic acid diester in which the substituent (R^{αx}) is substituted with a substituent having an ester bond or α-hydroxyacryl ester in which the substituent (R^{αx}) is substituted with a hydroxyalkyl group or a group in which a hydroxyl group thereof is modified can be mentioned as an acrylic acid ester. The carbon atom at the α-position of acrylic acid ester indicates the carbon atom bonded to the carbonyl group of acrylic acid unless otherwise specified.

The term “derivative” includes a compound in which the hydrogen atom at the α-position of the object compound has been substituted with another substituent such as an alkyl group or a halogenated alkyl group; and derivatives thereof. As the derivatives thereof, a derivative in which the hydrogen atom of the hydroxyl group of the object compound in which the hydrogen atom at the α-position may be substituted with a substituent is substituted with an organic group; a derivative in which a substituent other than a hydroxyl group is bonded to the object compound in which the hydrogen atom at the α-position may be substituted with a substituent; and the like are exemplary examples. The α-position refers to a first carbon atom adjacent to the functional group unless otherwise specified.

An expression “may have a substituent” includes a case where a hydrogen atom (—H) is substituted with a monovalent group and a case where a methylene group (—CH₂—) is substituted with a divalent group.

In the present specification and the scope of the present claims, asymmetric carbon atoms may be present, and thus enantiomers or diastereomers may be present depending on the structures represented by the chemical formula. In that case, these isomers are represented by one chemical formula. These isomers may be used alone or in the form of a mixture.

### (Method for Producing Polymer (1))

The method for producing a polymer according to a first embodiment of the present invention includes a step of reacting a polymer (P1) having a structure represented by General Formula (t1-1) at a terminal of a main chain with a nucleophilic agent in which a pKa of a conjugate acid is 11 or less to obtain a polymer (P2) having a structure represented by Formula (t2-1) at a terminal of a main chain.

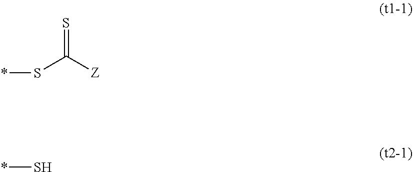

[in General Formula (t1-1), Z represents a monovalent organic group; and * represents a bonding site bonded to a carbon atom which constitutes a main chain of an adjacent constitutional unit,

in General Formula (t2-1), * represents a bonding site bonded to a carbon atom which constitutes a main chain of an adjacent constitutional unit]

### <Polymer (P1)>

The polymer (P1) is a polymer having a structure represented by General Formula (t1-1) (hereinafter, also referred to as “terminal structure (T1)”) at the terminal of the main chain.

### <<Main Chain Terminal Structure>>

The polymer (P1) has the terminal structure (T1) represented by General Formula (t1-1) at the terminal of the main chain.

In General Formula (t1-1), Z represents a monovalent organic group. As the monovalent organic group of Z, a monovalent hydrocarbon group which may have a substituent is an exemplary example. As a hetero atom which may be included in the above-described monovalent hydrocarbon group, a nitrogen atom, an oxygen atom, a sulfur atom, a halogen atom, a silicon atom, and a phosphorus atom are exemplary examples. In one embodiment, the polymer (P1) is a polymer obtained by RAFT polymerization. In this case, Z in Formula (t1-1) may be a group derived from a RAFT agent used for the RAFT polymerization.

The above-described structure represented by General Formula (t1-1) is preferably structures represented by General Formulae (t1-1-1) to (t1-1-4).

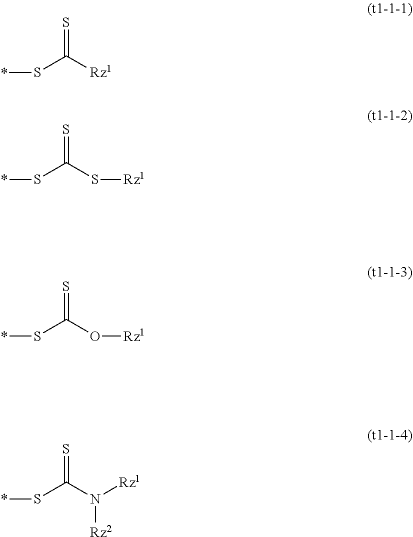

[in the formulae, Rz¹ and Rz² are each independently a monovalent organic group, Rz¹ and Rz² in Formula (t1-1-4) may be bonded to each other to form a ring together with a nitrogen atom in the formula; and * represents a bonding site bonded to a carbon atom which constitutes a main chain of an adjacent constitutional unit]

As the monovalent organic group of Rz¹ and Rz², a monovalent hydrocarbon group which may have a substituent is an exemplary example. The above-described monovalent hydrocarbon group preferably has 1 to 20 carbon atoms, more preferably has 1 to 16 carbon atoms, and still more preferably has 1 to 10 carbon atoms. The above-described monovalent hydrocarbon group may be an aliphatic hydrocarbon group or an aromatic hydrocarbon group.

The aliphatic hydrocarbon group of Rz¹ and Rz² may be saturated or unsaturated, but is preferably saturated. As the aliphatic hydrocarbon group of Rz¹ and Rz², an alkyl group which may have a substituent is an exemplary example. The above-described alkyl group may be linear, branched, or cyclic, but a linear or branched alkyl group is preferable.

The linear alkyl group preferably has 1 to 20 carbon atoms, more preferably has 1 to 16 carbon atoms, still more preferably has 1 to 10 carbon atoms, and particularly preferably has 1 to 6 carbon atoms. As specific examples of the linear alkyl group, for example, a methyl group, an ethyl group, an n-propyl group, an n-butyl group, a hexyl group, a heptyl group, an octyl group, a nonyl group, a decyl group, an undecyl group, a dodecyl group, a tridecyl group, a tetradecyl group, a pentadecyl group, a lauryl group, a stearyl group, and the like are exemplary examples.

The branched alkyl group preferably has 3 to 20 carbon atoms, more preferably has 3 to 16 carbon atoms, still more preferably has 3 to 10 carbon atoms, and particularly preferably has 3 to 6 carbon atoms. As the branched alkyl group, for example, an isopropyl group, an isobutyl group, a tert-butyl group, and the like are exemplary examples.

The alkyl group of Rz¹ and Rz² may or may not have a substituent. As the substituent which may be included in the above-described alkyl group, for example, an epoxy group, a hydroxyl group, an alkoxy group, an acyl group, an acyloxy group, a formyl group, an alkylcarbonyl group, a carboxy group, a sulfonic acid group, an alkoxycarbonyl group, an aryloxycarbonyl group, an isocyanate group, a cyano group, a silyl group, a halogen atom, an amino group, and the like are exemplary examples.

The aromatic hydrocarbon group of Rz¹ and Rz² is a hydrocarbon group having at least one aromatic ring. The aromatic ring may be monocyclic or polycyclic. The aromatic ring preferably has 5 to 30 carbon atoms, more preferably has 5 to 20 carbon atoms, still more preferably has 6 to 15 carbon atoms, and particularly preferably has 6 to 12 carbon atoms.

As specific examples of the aromatic ring, aromatic hydrocarbon rings such as benzene, naphthalene, anthracene, and phenanthrene; an aromatic heterocyclic ring obtained by substituting a part of carbon atoms constituting the above-described aromatic hydrocarbon ring with a hetero atom; and the like are exemplary examples. As the hetero atom in the aromatic heterocyclic ring, an oxygen atom, a sulfur atom, and a nitrogen atom are exemplary examples. Specifically, as the aromatic heterocyclic ring, a pyridine ring and a thiophene ring are exemplary examples.

Specifically, as the aromatic hydrocarbon group, a group (an aryl group or a heteroaryl group) formed by removing one hydrogen atom from the aromatic hydrocarbon ring or aromatic heterocyclic ring; a group formed by removing one hydrogen atom from an aromatic compound (for example, biphenyl, fluorene, or the like) having two or more aromatic rings; and a group (for example, an arylalkyl group such as a benzyl group, a phenethyl group, a 1-naphthylmethyl group, a 2-naphthylmethyl group, a 1-naphthylethyl group, and a 2-naphthylethyl group) in which one hydrogen atom in an aromatic hydrocarbon ring or aromatic heterocyclic ring is substituted with an alkylene group are exemplary examples. The alkylene group bonded to the aromatic hydrocarbon ring or the aromatic heterocyclic ring preferably has 1 to 4 carbon atoms, and more preferably 1 or 2 carbon atoms.

The aryl group preferably has 6 to 20 carbon atoms, more preferably has 6 to 15 carbon atoms, and still more preferably has 6 to 12 carbon atoms. As the aryl group, for example, a phenyl group, a 1-naphthyl group, a 2-naphthyl group, a 1-anthracenyl group, and the like are exemplary examples.

The aryl group may or may not have a substituent. As the substituent which may be included in the aryl group, for example, an epoxy group, a hydroxyl group, an alkoxy group, an acyl group, an acyloxy group, a formyl group, an alkylcarbonyl group, a carboxy group, a sulfonic acid group, an alkoxycarbonyl group, an aryloxycarbonyl group, an isocyanate group, a cyano group, a silyl group, a halogen atom, an amino group, an alkyl group, and the like are exemplary examples.

The heteroaryl group preferably has 5 to 20 carbon atoms, more preferably has 5 to 15 carbon atoms, and still more preferably has 5 to 12 carbon atoms. As the heteroaryl group, for example, a pyridyl group, a quinolyl group, an isoquinolyl group, a pyrimidinyl group, and the like are exemplary examples.

The heteroaryl group may or may not have a substituent. As the substituent which may be included in the heteroaryl group, for example, an epoxy group, a hydroxyl group, an alkoxy group, an acyl group, an acyloxy group, a formyl group, an alkylcarbonyl group, a carboxy group, a sulfonic acid group, an alkoxycarbonyl group, an aryloxycarbonyl group, an isocyanate group, a cyano group, a silyl group, a halogen atom, an amino group, an alkyl group, and the like are exemplary examples.

As the arylalkyl group of Rz¹ and Rz², groups in which one or more hydrogen atoms of the alkyl group mentioned above are substituted with the aryl group mentioned above are exemplary examples. As specific examples of the arylalkyl group, those described above are exemplary examples. The arylalkyl group may or may not have a substituent. As the substituent which may be included in the arylalkyl group, substituents mentioned as the substituents for the alkyl group and the aryl group described above are exemplary examples.

Rz¹ and Rz² in Formula (t1-1-4) may be bonded to each other to form a ring together with a nitrogen atom in the formula. As the above-described ring, for example, a pyrrole ring, a pyrazole ring, an imidazole ring, a pyrrolidine ring, a piperidine ring, a piperazine ring, a pyridine ring, a pyrimidine ring, a pyrazine ring, an oxazole ring, a thiazole ring, a morpholine ring, a thiazine ring, a triazole ring, and the like are exemplary examples. The ring formed by bonding Rz¹ and Rz² to each other may or may not have a substituent. As the substituent which may be included in the above-described ring, for example, an alkyl group, an oxo group (═O), an epoxy group, a hydroxyl group, an alkoxy group, an acyl group, an acyloxy group, a formyl group, an alkylcarbonyl group, a carboxy group, a sulfonic acid group, an alkoxycarbonyl group, an aryloxycarbonyl group, an isocyanate group, a cyano group, a silyl group, a halogen atom, an amino group, and the like are exemplary examples.

Specific examples of the structure represented by Formula (t1-1-1) are shown below, but the present invention is not limited thereto. In the formula, * represents a bonding site bonded to a carbon atom which constitutes a main chain of an adjacent constitutional unit.

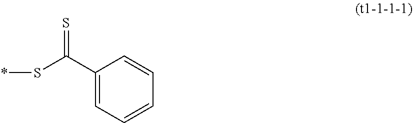 [SMILES: *SC(=S)c1ccccc1]

Specific examples of the structure represented by Formula (t1-1-2) are shown below, but the present invention is not limited thereto. In the formulae, * represents a bonding site bonded to a carbon atom which constitutes a main chain of an adjacent

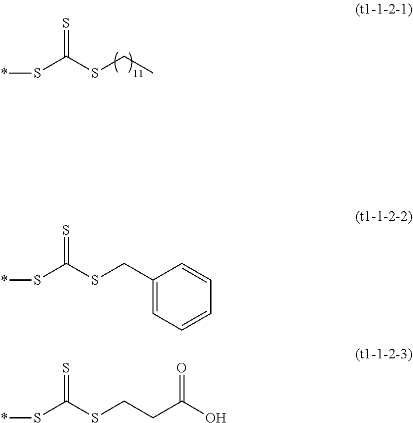

Specific examples of the structure represented by Formula (t1-1-3) are shown below, but the present invention is not limited thereto. In the formulae, * represents a bonding site bonded to a carbon atom which constitutes a main chain of an adjacent constitutional unit.

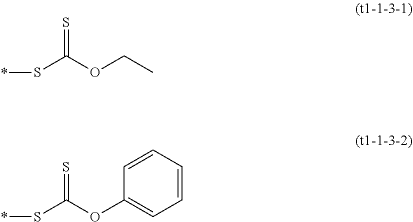

Specific examples of the structure represented by Formula (t1-1-4) are shown below, but the present invention is not limited thereto. In the formulae, * represents a bonding site bonded to a carbon atom which constitutes a main chain of an adjacent constitutional unit.

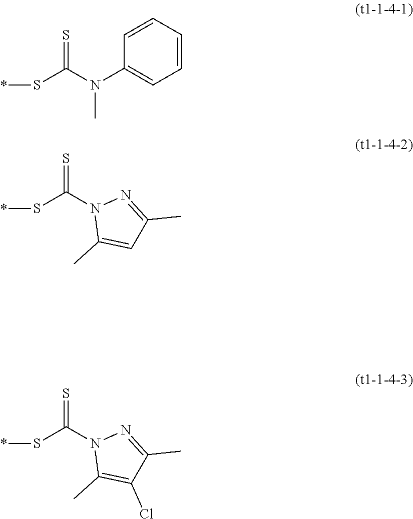 [SMILES: *SC(=S)N(C)c1ccccc1 ; *SC(=S)n1nc(C)cc1C ; *SC(=S)n1nc(C)c(Cl)c1C]

The polymer (P1) preferably has a constitutional unit (u1) derived from (α-substituted) acrylic acid or (α-substituted) acrylic acid ester, the constitutional unit being adjacent to the terminal structure (T1).

As the (α-substituted) acrylic acid ester from which the constitutional unit (u1) is derived, acrylic acid ester and α-substituted acrylic acid ester are exemplary examples. As a substituent for substituting the hydrogen atom bonded to the carbon atom at the α-position in the α-substituted acrylic acid ester, for example, an alkyl group having 1 to 5 carbon atoms, a halogenated alkyl group having 1 to 5 carbon atoms, a hydroxyalkyl group, and the like are exemplary examples.

As specific examples of the (α-substituted) acrylic acid ester, acrylic acid esters such as methyl acrylate, ethyl acrylate, propyl acrylate, n-butyl acrylate, t-butyl acrylate, cyclohexyl acrylate, octyl acrylate, nonyl acrylate, hydroxyethyl acrylate, hydroxypropyl acrylate, benzyl acrylate, anthracene acrylate, glycidyl acrylate, 3,4-epoxycyclohexylmethane acrylate, and propyltrimethoxysilane acrylate; methacrylic acid esters such as methyl methacrylate, ethyl methacrylate, propyl methacrylate, n-butyl methacrylate, t-butyl methacrylate, cyclohexyl methacrylate, octyl methacrylate, nonyl methacrylate, hydroxyethyl methacrylate, hydroxypropyl methacrylate, benzyl methacrylate, anthracene methacrylate, glycidyl methacrylate, 3,4-epoxycyclohexylmethane methacrylate, and propyltrimethoxysilane methacrylate; and the like are exemplary examples.

As the (α-substituted) acrylic acid, for example, acrylic acid and α-substituted acrylic acid are exemplary examples. As a substituent for substituting the hydrogen atom bonded to the carbon atom at the α-position in the α-substituted acrylic acid, for example, an alkyl group having 1 to 5 carbon atoms, a halogenated alkyl group having 1 to 5 carbon atoms, a hydroxyalkyl group, and the like are exemplary examples.

As specific examples of the (α-substituted) acrylic acid, acrylic acid, methacrylic acid, and the like are exemplary examples.

The polymer (P1) preferably has a structure represented by General Formula (t1-2) at the terminal of the main chain.

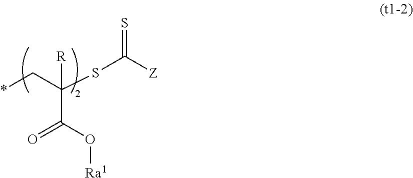

[in the formula, Z represents a monovalent organic group; R represents a hydrogen atom, an alkyl group having 1 to 5 carbon atoms, or a halogenated alkyl group having 1 to 5 carbon atoms; Ra¹ represents a hydrogen atom or a monovalent organic group; and * represents a bonding site bonded to a carbon atom which constitutes a main chain of an adjacent constitutional unit]

In Formula (t1-2), Z is the same as Z in General Formula (t1-1) described above. Z is preferably a group represented by —Rz¹, —SRz¹, —ORz¹, or —NRz¹Rz² (Rz¹ and Rz² each independently represent a monovalent organic group). Rz¹ and Rz² are the same as Rz¹ and Rz² in General Formulae (t1-1-1) to (t1-1-4) described above.

In Formula (t1-2), R represents a hydrogen atom, an alkyl group having 1 to 5 carbon atoms, or a halogenated alkyl group having 1 to 5 carbon atoms.

The alkyl group having 1 to 5 carbon atoms of R is preferably a linear or branched alkyl group having 1 to 5 carbon atoms. As specific examples thereof, a methyl group, an ethyl group, an n-propyl group, an isopropyl group, an n-butyl group, an isobutyl group, a tert-butyl group, a pentyl group, an isopentyl group, and a neopentyl group are exemplary examples.

The halogenated alkyl group having 1 to 5 carbon atoms of R is a group obtained by substituting part or all of hydrogen atoms of the above-described alkyl group having 1 to 5 carbon atoms with a halogen atom. As the halogen atom, a fluorine atom, a chlorine atom, a bromine atom, an iodine atom, and the like are exemplary examples, and a fluorine atom is preferable.

R is more preferably a hydrogen atom or an alkyl group having 1 to 5 carbon atoms, still more preferably a hydrogen atom or a methyl group, and particularly preferably a methyl group.

In General Formula (t1-2), Ra¹ represents a hydrogen atom or a monovalent organic group.

As the monovalent organic group of Ra¹, a monovalent hydrocarbon group which may have a substituent is an exemplary example. The hydrocarbon group which may have a substituent may be an aliphatic hydrocarbon group which may have a substituent or an aromatic hydrocarbon group which may have a substituent. The aliphatic hydrocarbon group which may have a substituent may be saturated or unsaturated. As the monovalent organic group of Ra, a cyclic group which may have a substituent, and a linear or branched aliphatic hydrocarbon group which may have a substituent are exemplary examples.

Cyclic Group which May have Substituent:

The cyclic group which may have a substituent is preferably a cyclic hydrocarbon group which may have a substituent. The cyclic hydrocarbon group which may have a substituent may be an aromatic hydrocarbon group which may have a substituent or a cyclic aliphatic hydrocarbon group which may have a substituent.

The aromatic hydrocarbon group of Ra¹ preferably has 3 to 30 carbon atoms, more preferably has 5 to 30 carbon atoms, still more preferably has 5 to 20 carbon atoms, particularly preferably has 6 to 15 carbon atoms, and most preferably has 6 to 10 carbon atoms. Here, the number of carbon atoms does not include the number of carbon atoms in a substituent.

Specifically, as the aromatic ring included in the aromatic hydrocarbon group of Ra¹, benzene, fluorene, naphthalene, anthracene, phenanthrene, biphenyl, an aromatic heterocyclic ring obtained by substituting a part of carbon atoms constituting these aromatic rings with a hetero atom, and the like are exemplary examples. As the hetero atom in the aromatic heterocyclic ring, an oxygen atom, a sulfur atom, and a nitrogen atom are exemplary examples.

Specifically, as the aromatic hydrocarbon group of Ra¹, a group obtained by removing one hydrogen atom from the above-described aromatic ring (an aryl group; for example, a phenyl group, a naphthyl group, or the like), a group in which one hydrogen atom in the aromatic ring has been substituted with an alkylene group (for example, an arylalkyl group such as a benzyl group, a phenethyl group, a 1-naphthylmethyl group, a 2-naphthylmethyl group, 1-naphthylethyl group, a 2-naphthylethyl group, or the like), and the like are exemplary examples. The alkylene group (alkyl chain in the arylalkyl group) preferably has 1 to 4 carbon atoms, more preferably has 1 or 2 carbon atoms, and particularly preferably has 1 carbon atom.

As the cyclic aliphatic hydrocarbon group of Ra¹, aliphatic hydrocarbon groups including a ring in the structure thereof are exemplary examples. As the aliphatic hydrocarbon group including a ring in the structure, an alicyclic hydrocarbon group (a group formed by removing one hydrogen atom from an aliphatic hydrocarbon ring), a group in which an alicyclic hydrocarbon group is bonded to the terminal of a linear or branched aliphatic hydrocarbon group, and a group in which an alicyclic hydrocarbon group is interposed in a linear or branched aliphatic hydrocarbon group are exemplary examples. The cyclic aliphatic hydrocarbon group may be saturated or may be unsaturated.

The above-described alicyclic hydrocarbon group preferably has 3 to 20 carbon atoms, and more preferably has 3 to 12 carbon atoms.

The alicyclic hydrocarbon group of Ra¹ may be a polycyclic group or a monocyclic group. As the monocyclic alicyclic hydrocarbon group, a group formed by removing one or more hydrogen atoms from a monocycloalkane is preferable. The monocycloalkane preferably has 3 to 6 carbon atoms. As specific examples of the monocycloalkane, cyclopentane, cyclohexane, and the like are exemplary examples. As the polycyclic alicyclic hydrocarbon group, a group formed by removing one or more hydrogen atoms from a polycycloalkane is preferable, and the polycycloalkane preferably has 7 to 30 carbon atoms. As specific examples of the polycycloalkane, polycycloalkanes having a bridged ring-based polycyclic skeleton, such as adamantane, norbornane, isobornane, tricyclodecane, and tetracyclododecane, are exemplary examples.

The linear or branched aliphatic hydrocarbon group which may be bonded to the alicyclic hydrocarbon group preferably has 1 to 10 carbon atoms, more preferably has 1 to 6 carbon atoms, still more preferably has 1 to 4 carbon atoms, and particularly preferably has 1 to 3 carbon atoms.

The cyclic hydrocarbon group of Ra¹ may include a hetero atom such as a heterocyclic ring. As the hetero atom, an oxygen atom, a sulfur atom, and a nitrogen atom are exemplary examples.

The cyclic group of Ra¹ may or may not have a substituent. As the substituent in the cyclic group of Ra¹, an alkyl group, an alkoxy group, a halogen atom, a halogenated alkyl group, a hydroxyl group, a carboxy group, a carbonyl group, a nitro group, and the like are exemplary examples.

As the alkyl group as the substituent, an alkyl group having 1 to 5 carbon atoms is preferable, and a methyl group, an ethyl group, a propyl group, an n-butyl group, and a tert-butyl group, and the like are exemplary examples.

As the alkoxy group as the substituent, an alkoxy group having 1 to 5 carbon atoms is preferable, a methoxy group, an ethoxy group, an n-propoxy group, an iso-propoxy group, an n-butoxy group, or a tert-butoxy group is preferable, and a methoxy group, an ethoxy group, and the like are exemplary examples.

As the halogen atom as the substituent, a fluorine atom and a chlorine atom are exemplary examples, and a fluorine atom is preferable.

As the halogenated alkyl group as the substituent, a group in which a part of or all of hydrogen atoms in the alkyl group having 1 to 5 carbon atoms are substituted with the halogen atoms (fluorine atom and the like) is an exemplary example.

The carbonyl group as the substituent is a group that substitutes a methylene group (—CH₂—) constituting the cyclic hydrocarbon group.

Linear or Branched Aliphatic Hydrocarbon Group which May have Substituent:

The linear or branched aliphatic hydrocarbon group which may have a substituent of Ra¹ may be a saturated aliphatic hydrocarbon group or an unsaturated aliphatic hydrocarbon group. The linear or branched aliphatic hydrocarbon group which may have a substituent preferably has 1 to 20 carbon atoms, more preferably has 1 to 15 carbon atoms, still more preferably has 1 to 10 carbon atoms, and particularly preferably has 1 to 6 carbon atoms. Here, the number of carbon atoms does not include the number of carbon atoms in a substituent.

As the linear or branched aliphatic hydrocarbon group which may have a substituent of Ra¹, a linear or branched alkyl group which may have a substituent and a linear or branched alkenyl group which may have a substituent are exemplary examples.

The linear alkyl group of Ra¹ preferably has 1 to 20 carbon atoms, more preferably has 1 to 15 carbon atoms, still more preferably has 1 to 10 carbon atoms, and particularly preferably has 1 to 6 carbon atoms.

The branched alkyl group preferably has 3 to 20 carbon atoms, more preferably has 3 to 15 carbon atoms, still more preferably has 3 to 10 carbon atoms, and particularly preferably has 3 to 6 carbon atoms. As specific examples thereof, a 1-methylethyl group, a 1-methylpropyl group, a 2-methylpropyl group, a 1-methylbutyl group, a 2-methylbutyl group, a 3-methylbutyl group, a 1-ethylbutyl group, a 2-ethylbutyl group, a 1-methylpentyl group, a 2-methylpentyl group, a 3-methylpentyl group, a 4-methylpentyl group, and the like are exemplary examples.

The linear alkenyl group of Ra¹ preferably has 2 to 10 carbon atoms, more preferably has 2 to 5 carbon atoms, still more preferably has 2 to 4 carbon atoms, and particularly preferably has 3 carbon atoms. As the linear alkenyl group, a vinyl group, a propenyl group (an allyl group), and a butynyl group are exemplary examples. The branched alkenyl group of Ra¹ preferably has 3 to 10 carbon atoms, more preferably has 3 to 5 carbon atoms, and still more preferably has 3 or 4 carbon atoms. As the branched alkenyl group, a 1-methylvinyl group, a 2-methylvinyl group, a 1-methylpropenyl group, and a 2-methylpropenyl group are exemplary examples.

The linear or branched aliphatic hydrocarbon group of Ra¹ may or may not have a substituent. As the substituent in the linear or branched aliphatic hydrocarbon group of Ra¹, for example, an alkoxy group, a halogen atom, a halogenated alkyl group, a hydroxyl group, a carboxy group, a carbonyl group, a nitro group, an amino group, and the like are exemplary examples.

Specific examples of the terminal of the main chain of the polymer (P1) are shown below, but the present invention is not limited thereto. In the following formula, Ra is a hydrogen atom, a methyl group, or a trifluoromethyl group. * represents a bonding site bonded to a carbon atom which constitutes a main chain of an adjacent constitutional unit.

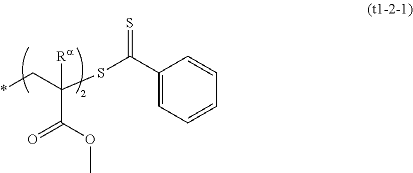

### <<Constitutional Unit Included in Polymer (P1)>>

The constitutional unit included in the polymer (P1) is not particularly limited, but the polymer (P1) preferably has a constitutional unit derived from a radically polymerizable unsaturated group-containing monomer. As the radically polymerizable unsaturated group-containing monomer, for example, in addition to the (α-substituted) acrylic acid or the (α-substituted) acrylic acid ester described above, styrene or styrene derivatives, aliphatic terminal olefin compounds, halogen-containing olefin compounds, nitrogen-containing olefin compounds, carboxy group-containing unsaturated compounds, cyclization polymerizable compounds, silicon-containing unsaturated compounds, unsaturated group-containing macromonomers, and the like are exemplary examples.

As the styrene derivative, α-methylstyrene, 2-methylstyrene, 3-methylstyrene, 4-methylstyrene, 4-t-butylstyrene, 4-n-octylstyrene, 2,4,6-trimethylstyrene, 4-methoxystyrene, 4-t-butoxystyrene, 4-hydroxystyrene, 4-nitrostyrene, 3-nitrostyrene, 4-chlorostyrene, 4-fluorostyrene, 4-acetoxyvinylstyrene, 4-vinylbenzyl chloride, diethylaminostyrene, diethylamino α-methylstyrene, 4-vinylbenzenesulfonic acid, 4-sodium vinylbenzenesulfonate, 2,5-dimethylstyrene, and the like are exemplary examples.

As the aliphatic terminal olefin compound, ethylene, propylene, 1-butene, 1-heptene, 1-hexene, 1-octene, isobutylene, butadiene, isoprene, and the like are exemplary examples.

As the halogen-containing olefin compound, vinyl chloride, vinyl fluoride, vinyl bromide, chloroprene, vinylidene chloride, and the like are exemplary examples.

As the nitrogen-containing olefin compound, acrylamide, methacrylamide, N-methyl acrylamide, N-methyl methacrylamide, N,N-dimethyl acrylamide, N,N-dimethyl methacrylamide, N-t-butyl acrylamide, N-t-butyl methacrylamide, N-n-butyl acrylamide, N-n-butyl methacrylamide, N-methylol acrylamide, N-methylol methacrylamide, N-ethylol acrylamide, N-ethylol methacrylamide, acrylonitrile, methacrylonitrile, N-phenylmaleimide, N-butylmaleimide, 4-vinylpyridine, N-vinylpyrrolidone, N-vinylcarbazole, and the like are exemplary examples.

As the carboxy group-containing unsaturated compound, p-vinyl benzoic acid, vinyl benzoate, itaconic acid, itaconic anhydride, α-methylvinyl benzoic acid, vinyl acetate, vinyl butanoate, maleic anhydride, allyl acetate, allyl benzoate, and the like are exemplary examples.

As the cyclization polymerizable compound, diallyl ammonium chloride, 1,6-heptadiene, compounds having a 1,6-heptadiene structure such as 2,6-dicyano-1,6-heptadiene and 2,4,4,6-tetrakis(ethoxycarbonyl)-1,6-heptadiene, and the like are exemplary examples.

As the silicon-containing unsaturated compound, dimethylvinylsilane, trimethylvinylsilane, dimethylphenylvinylsilane, dimethoxymethylvinylsilane, diethoxyphenylvinylsilane, trimethoxyvinylsilane, pentamethylvinyldisiloxane, trimethylallylsilane, trimethoxyallylsilane, dimethoxymethylallylsilane, heptamethylvinylcyclotetrasiloxane, 1,1,3,3-tetramethyldivinyldisiloxane, and the like are exemplary examples.

As the unsaturated group-containing macromonomer, allyl-terminated polyethylene oxide, allyl-terminated polypropylene oxide, allyl-terminated polyethylene oxide-polypropylene oxide copolymer, vinyl-terminated polyethylene oxide, vinyl-terminated polypropylene oxide, vinyl-terminated polyethylene oxide-polypropylene oxide copolymer, methallyl-terminated polypropylene oxide, vinyl-terminated polytetramethylene oxide, acryloyl-terminated polyacrylic acid, methacryloyl-terminated polymethacrylic acid, acryloyl-terminated polyacrylate, acryloyl-terminated polymethacrylate, methacryloyl-terminated acrylate, methacryloyl-terminated methacrylate, vinyl-terminated polysiloxane, vinyl-terminated polycarbonate, allyl-terminated polycarbonate, vinyl-terminated polyethylene terephthalate, vinyl-terminated polybutylene terephthalate, vinyl-terminated caprolactam, vinyl-terminated polyamide, vinyl-terminated polyurethane, and the like are exemplary examples.

Among these, as the constitutional unit included in the polymer (P1), the constitutional unit derived from (α-substituted) acrylic acid or (α-substituted) acrylic acid ester and the constitutional unit derived from styrene or styrene derivative are exemplary examples.

The number of kinds of the constitutional units included in the polymer (P1) is not particularly limited, and may be 1 or 2 or more. The polymer (P1) may be a homopolymer, or may be a copolymer of two or more kinds of unsaturated-group containing monomers. In a case where the polymer (P1) is a copolymer, the polymer (P1) may be a block copolymer or a random copolymer.

### <<Method for Producing Polymer (P1)>>

The polymer (P1) can be synthesized by the RAFT polymerization. The RAFT polymerization can be carried out by a known method using a polymerization initiator and a RAFT agent.

Polymerization Initiator:

The polymerization initiator is not particularly limited as long as the polymerization initiator generates free radicals typically used for the RAFT polymerization, and known polymerization initiators can be used. As the polymerization initiator, for example, a thermal polymerization initiator (peroxide, peroxy ester, azo compound, or the like), a photopolymerization initiator, a redox polymerization initiator, and the like are exemplary examples. In addition, free radical generation means using high energy radiation such as an electron beam, an X-ray, and a γ-ray may be used.

As the thermal polymerization initiator, for example, 2,2′-azobis(isobutyronitrile), 2,2′-azobis(2-cyanobutane), dimethyl 2,2′-azobis(isobutyrate), 4,4′-azobis(4-cyanovaleric acid), 1,1′-azobis(cyclohexanecarbonitrile) (ACHN), 2,2′-azobis(2-methylbutyronitrile) (ABN-E), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(2-hydroxyethyl)propionamide] (AMHP), 4,4′-azobis(4-cyanopentanoic acid) (ACPA), 2,2′-azobis(5-hydroxy-2-methylpentanenitrile) (AHPN), 2,2′-azobis(N,N′-dimethyleneisobutylamidine) dihydrochloride, 2,2′-azobis(2-amidinopropane) dihydrochloride, 2,2′-azobis(N,N′-dimethyleneisobutyl amidine), 2,2′-azobis{2-methyl-N-[1,1-bis(hydroxymethyl)-2-hydroxyethyl]propionamide}, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide) dihydrate, 2,2′-azobis(2,2,4-trimethylpentane), 2,2′-azobis(2-methylpropane), t-butylperoxy acetate, t-butyl peroxybenzoate, t-butyl peroxyneodecanoate, t-butyl peroxyisobutyrate, t-amyl peroxypivalate, t-butyl peroxypivalate, diisopropyl peroxydicarbonate, dicyclohexyl peroxydicarbonate, dicumyl peroxide, dibenzoyl peroxide (BPO), dilaurolyl peroxide (LPO), potassium peroxydisulfate, ammonium peroxydisulfate, tert-butyl 2-ethylhexane peroxoate, di-t-butyl hyponitrite, dicumyl hyponitrite, and the like are exemplary examples.

As the photopolymerization initiator, for example, a benzene derivative, benzophenone, acylphosphine oxide, a photooxidization-reduction system, and the like are exemplary examples.

As the redox polymerization initiator, for example, combinations of oxidizing substances (potassium, peroxydisulfate, hydrogen peroxide, t-butyl hydroperoxide, and the like) and reducing substances (iron (II), titanium (III), thio potassium sulfate, potassium hydrogen sulfite, and the like) are exemplary examples.

The amount of the polymerization initiator used can be appropriately set according to the type and amount of the unsaturated group-containing monomer. For example, from the viewpoint of stably carrying out the polymerization reaction, the amount of the polymerization initiator used can be 0.001 to 1.0 mol, preferably 0.005 to 0.5 mol and more preferably 0.01 to 0.3 mol with respect to 1 mol of the amount of the RAFT agent used.

Raft Agent:

As the RAFT agent, it is possible to use known RAFT agents without particular limitation. As the RAFT agent, a compound having a thiocarbonylthio structure is an exemplary example. As the compound having a thiocarbonylthio structure (—C(═S)—S—), a compound represented by General Formula (1) is an exemplary example.

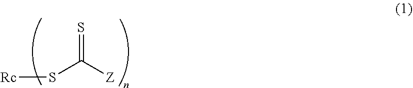

[in the formula, Z represents a monovalent organic group; Rc represents an n-valent organic group; and n represents an integer of 1 or more]

In Formula (1), Z is the same as Z in General Formula (t1-1) described above. Z is preferably a group represented by —Rz¹, —SRz¹, —ORz¹, or —NRz¹Rz² (Rz¹ and Rz² each independently represent a monovalent organic group). Rz¹ and Rz² are the same as Rz¹ and Rz² in General Formulae (t1-1-1) to (t1-1-4) described above.

As the organic group of Rc in Formula (1), a hydrocarbon group which may have a substituent is an exemplary example. As Rc, the same groups as those for Z in General Formula (t1-1) are exemplary examples. The n-valent organic group of Rc has a carbon atom bonded to a group represented by —S—C(═S)—Z, and the carbon atom can serve as a starting point for the RAFT polymerization reaction with the unsaturated group-containing monomer. From the viewpoint of reactivity and the like of the RAFT polymerization, the carbon atom is preferably bonded to sp2-hybridized orbital carbon or sp-hybridized orbital carbon included in Rc. As the sp2-hybridized orbital carbon or sp-hybridized orbital carbon, for example, a carbon atom on an aromatic ring, a carbon atom on a heteroaromatic ring, a carbon atom on a carbonyl group (C═O), a carbon atom on a cyano group, and the like are exemplary examples.

As specific examples of the RAFT agent, dithioesters such as 2-cyano-2-propylbenzodithioate and 4-cyano-4-(phenylcarbonothioylthio)pentanoic acid; trithiocarbonates such as 2-cyano-2-propyldodecyltrithiocarbonate, 4-cyano-4-[(dodecylsulfanylthiocarbonyl)sulfanyl]pentanoic acid, 2-(dodecylthiocarbonothioylthio)-2-methylpropionic acid, and cyanomethyldodecyl trithiocarbonate; dithiocarbamates such as cyanomethylmethyl (phenyl)carbamodithioate; and disulfides such as bis(thiobenzoyl)disulfide and bis(dodecylsulfanylthiocarbonyl)disulfide are exemplary examples.

One kind of the RAFT agent may be used alone, or two or more kinds thereof may be used in combination.

The amount of the RAFT agent used is not particularly limited, and can be appropriately set according to the target number-average molecular weight (Mn) of the polymer (P1).

A method for the RAFT polymerization is not particularly limited, and known methods such as solution polymerization, bulk polymerization, emulsion polymerization, suspension polymerization, and fine suspension polymerization can be used.

In the case of solution polymerization, as a solvent to be used, for example, hydrocarbon-based solvents such as heptane, hexane, octane, and mineral spirits; ester-based solvents such as ethyl acetate, n-butyl acetate, isobutyl acetate, ethylene glycol monomethyl ether acetate, and diethylene glycol monobutyl ether acetate; ketone-based solvents such as acetone, methyl ethyl ketone, methyl isobutyl ketone, diisobutyl ketone, and cyclohexanone; alcohol-based solvents such as methanol, ethanol, isopropanol, n-butanol, sec-butanol, and isobutanol; ether-based solvents such as tetrahydrofuran, diethyl ether, di-n-butyl ether, dioxane, ethylene glycol dimethyl ether, and ethylene glycol diethyl ether; and aromatic petroleum-based solvents such as toluene, xylene, Swasol 310 (manufactured by COSMO ENERGY HOLDINGS Co., Ltd.), Swasol 1000 (manufactured by COSMO ENERGY HOLDINGS Co., Ltd.), and Swasol 1500 (manufactured by COSMO ENERGY HOLDINGS Co., Ltd.) are exemplary examples. The solvent may be used alone, or may be a mixed solvent of two or more types of solvents.

In the case of emulsion polymerization or fine suspension polymerization, as an emulsifier to be used, for example, anionic surfactants such as fatty acid soap, rosin acid soap, sodium naphthalene sulfonate formalin condensate, sodium alkylbenzene sulfonate, ammonium alkyl sulfate, triethanolamine alkyl sulfate, sodium dialkyl sulfosuccinate, sodium alkyldiphenyl ether disulfonate, sodium polyoxyethylene alkyl ether sulfate, and sodium polyoxyethylene alkyl phenyl ester sulfate; nonionic surfactants such as polyoxyethylene alkyl ether, polyoxyethylene higher alcohol ether, sorbitan fatty acid ester, polyoxyethylene sorbitan fatty acid ester, polyoxyethylene sorbitol fatty acid ester, glycerin fatty acid ester, polyoxyethylene fatty acid ester, polyoxyethylene alkylamine, and alkylalkanolamide; and cationic surfactants such as alkyltrimethylammonium chloride are exemplary examples. One kind of the emulsifier may be used alone, or two or more kinds thereof may be used in combination. As necessary, the cationic surfactant such as alkylamine hydrochloride may be used, or a dispersant for suspension polymerization described below may be added. The amount of the emulsifier used is not particularly limited, but is usually 0.1 to 20 parts by weight with respect to 100 parts by weight of the monomer.

In the case of suspension polymerization, as a dispersant to be used, for example, partially saponified polyvinyl acetate, polyvinyl alcohol, methyl cellulose, carboxymethyl cellulose, gelatin, polyalkylene oxide, combinations of anionic surfactant and dispersing aid, and the like are exemplary examples. One kind of the dispersant may be used alone, or two or more kinds thereof may be used in combination. The emulsifier for the above-described emulsion polymerization may be used in combination as necessary. The amount of the dispersant used is not particularly limited, but is usually 0.1 to 20 parts by weight with respect to 100 parts by weight of the monomer.

The RAFT polymerization reaction is preferably carried out in an inert gas atmosphere which does not contain oxygen. As the inert gas, for example, an argon gas is an exemplary example.

A reaction temperature during the polymerization reaction is preferably 40° C. or higher and 100° C. or lower, more preferably 45° C. or higher and 90° C. or lower, and still more preferably 50° C. or higher and 80° C. or lower. In a case where the reaction temperature is 40° C. or higher, the polymerization reaction can proceed smoothly. On the other hand, in a case where the reaction temperature is 100° C. or lower, side reactions can be suppressed, and restrictions on the usable initiator and solvent are relaxed.

### <Nucleophilic Agent>

The nucleophilic agent causes the above-described structure represented by Formula (t1-1) of the polymer (P1) to undergo a nucleophilic reaction, and is used to generate the above-described structure represented by Formula (t2-1) (thiol group). The nucleophilic agent used in the production method according to the present embodiment is a nucleophilic agent in which a pKa (acid dissociation constant) of a conjugate acid is 11 or less. The pKa is a pKa in dimethyl sulfoxide (DMSO). The pKa of the conjugate acid in DMSO can be calculated using, for example, thermodynamic property estimation software or the like. As such software, “BIOVIA COSMOtherm 2021” (manufactured by MOLSIS Inc.) is an exemplary example. In addition, the most stable structure of the conjugate acid used for calculating the pKa may be calculated using computational chemistry software or the like. As such software, for example, “Turbomole 7.5.1” (manufactured by MOLSIS Inc.) and “BIOVIA COSMOconf 2021” (manufactured by MOLSIS Inc.) are exemplary examples.

For example, Table 1 shows pKa of conjugate acids of various nucleophilic agents in DMSO.

TABLE 1

| Nucleophilic agent | pKa (DMSO) |
|---|---|
| Cyclohexylamine | 15.3 |
| Propylamine | 15.2 |
| Di-n-butylamine | 14.0 |
| Piperidine | 13.6 |
| 2,2,6,6-Tetramethylpiperazine | 13.0 |
| Morpholine | 11.7 |
| Triethylamine | 11.5 |
| 4-Dimethylaminopyridine | 11.3 |
| Tri-n-butylphosphine | 10.7 |
| Triethylphosphine | 9.3 |
| p-Methylpyridine | 7.5 |
| Aniline | 7.4 |
| Pyridine | 6.6 |
| Triphenylphosphine | 5.6 |
| Trimethyl phosphite | 3.6 |

Among the above-described nucleophilic agents, as a nucleophilic agent which can be used in the method according to the present embodiment, tri-n-butylphosphine, triethylphosphine, p-methylpyridine, aniline, pyridine, triphenylphosphine, and trimethylphosphite are exemplary examples.

In the production method according to the present embodiment, as the nucleophilic agent, for example, at least one selected from the group consisting of tertiary phosphine, pyridine, alkylpyridine, aniline, alkylaniline, and phosphorous acid ester can be used.

As the tertiary phosphine, a compound represented by General Formula (B1-1) is an exemplary example. As the pyridine and the alkylpyridine, a compound represented by General Formula (B1-2) is an exemplary example. As the phosphorous acid ester, a compound represented by General Formula (B1-3) is an exemplary example. As the aniline and the alkylaniline, a compound represented by General Formula (B1-4) is an exemplary example.

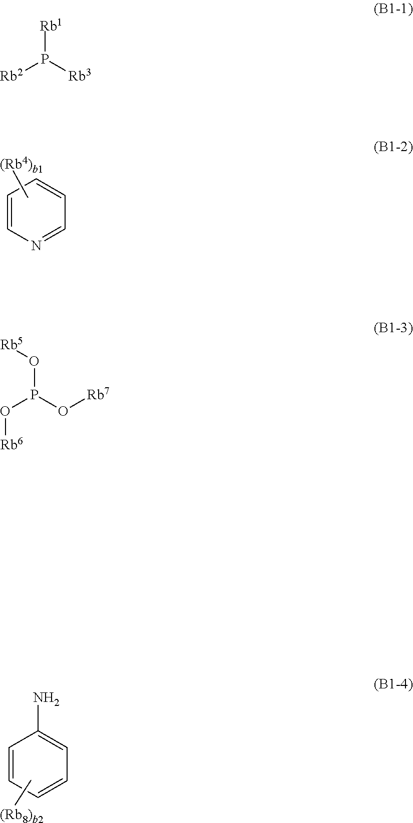

[in the formulae, Rb¹ to Rb³ and Rb⁵ to Rb⁷ each independently represent an alkyl group or an aryl group; Rb⁴ and Rb⁸ each independently represent an alkyl group; and b1 and b2 each independently represent an integer of 0 to 5]

In Formulae (B1-1) and (B1-3), Rb¹ to Rb³ and Rb⁵ to Rb⁷ each independently represent an alkyl group or an aryl group.

The alkyl group of Rb¹ to Rb³ and Rb⁵ to Rb⁷ may be linear, branched, or cyclic. The linear alkyl group preferably has 1 to 10 carbon atoms, more preferably has 1 to 8 carbon atoms, still more preferably has 1 to 5 carbon atoms, and particularly preferably has 1 to 4 carbon atoms.

The branched alkyl group preferably has 3 to 10 carbon atoms, more preferably has 3 to 8 carbon atoms, still more preferably has 3 to 6 carbon atoms, and particularly preferably has 3 or 4 carbon atoms.

The cyclic alkyl group may be monocyclic or polycyclic, but is preferably monocyclic. As the monocyclic cyclic alkyl group, a group formed by removing one or more hydrogen atoms from a monocycloalkane is preferable. The monocycloalkane preferably has 3 to 6 carbon atoms. As specific examples of the monocycloalkane, cyclopropane, cyclobutane, cyclopentane, cyclohexane, and the like are exemplary examples.

The aryl group of Rb¹ to Rb³ and Rb⁵ to Rb⁷ may be monocyclic or polycyclic, but is preferably monocyclic. As the aryl group, a phenyl group, a naphthyl group, a fluorenyl group, an anthracenyl group, a phenanthrenyl group, and the like are exemplary examples, and a phenyl group is preferable.

Rb¹ to Rb³ and Rb⁵ to Rb⁷ are preferably a linear or branched alkyl group or an aryl group, more preferably a linear or branched alkyl group having 1 to 5 carbon atoms or a phenyl group, still more preferably a linear or branched alkyl group having 1 to 4 carbon atoms or a phenyl group, and particularly preferably a methyl group, an ethyl group, a propyl group, an isopropyl group, an n-butyl group, or a phenyl group.

In Formulae (B1-2) and (B1-4), Rb⁴ and Rb⁸ each independently represent an alkyl group. As the alkyl group of Rb⁴ and Rb⁸, the same groups as the alkyl group Rb¹ to Rb³ and Rb⁵ to Rb⁷ described above are exemplary examples.

Rb⁴ and Rb⁸ are preferably a linear or branched alkyl group having 1 to 5 carbon atoms, more preferably a linear or branched alkyl group having 1 to 3 carbon atoms, and still more preferably a methyl group or an ethyl group.

In Formulae (B1-2) and (B1-4), b1 and b2 are each independently an integer of 0 to 5. b1 and b2 are preferably an integer of 0 to 3, more preferably an integer of 0 to 2, and still more preferably 0 or 1.

As specific examples of the tertiary phosphine, tri-n-butylphosphine, triphenylphosphine, triethylphosphine, trimethylphosphine, and the like are exemplary examples.

As specific examples of the alkylpyridine, p-methylpyridine, p-ethylpyridine, 2,6-dimethylpyridine, and the like are exemplary examples.

As specific examples of the phosphorous acid ester, trimethyl phosphite, triethyl phosphite, triphenyl phosphite, and the like are exemplary examples.

Among these, the nucleophilic agent is preferably tri-n-butylphosphine, triphenylphosphine, trimethyl phosphite, or p-methylpyridine.

In the production method according to the present embodiment, by using a basic compound in which the pKa of the conjugate acid is 11 or less, the formation of the thiolactone ring can suppressed, and a polymer (P2) having a structure represented by General Formula (t2-1) at the terminal of the main chain can be efficiently synthesized. In the reaction of converting the structure represented by General Formula (t1-1) into the structure represented by General Formula (t2-1), the thiolactone ring may be formed as a side reaction. Since the thiolactone ring has low reactivity, in a case where the thiolactone ring is formed, it is difficult to introduce a functional group into the terminal of the main chain of the polymer.

By using, as the nucleophilic agent, the basic compound in which the pKa of the conjugate acid is 11 or less, the side reaction can be suppressed, and the formation of the thiolactone ring can be suppressed. It is considered that this is because, by using, as the nucleophilic agent, a compound with a smaller pKa of the conjugate acid than a pKa (11.1) of the thiol group at the terminal of the main chain, deprotonation of the thiol group at the terminal of the main chain can be suppressed, and the formation of the thiolactone ring can be suppressed.

The amount of the nucleophilic agent used can be usually appropriately selected according to the equivalent of the group represented by General Formula (t1-1) included in the polymer (P1). From the viewpoint of reaction efficiency, a molar equivalent of the nucleophilic agent to the group represented by Formula (t1-1) is preferably 1 to 100 molar equivalents, more preferably 10 to 60 molar equivalents, and still more preferably 20 to 50 molar equivalents.

As a reaction solvent, it is possible to use a known solvent usually used for the nucleophilic reaction. As the reaction solvent, for example, nitrile-based solvents such as acetonitrile, isobutyronitrile, and benzonitrile; aromatic hydrocarbon-based solvents such as benzene, toluene, and xylene; ether-based solvents such as anisole, dibutyl ether, and tetrahydrofuran; ketone-based solvents such as acetone, methyl ethyl ketone, methyl isobutyl ketone and cyclohexanone; ester-based solvents such as methyl acetate, ethyl acetate, propyl acetate, and butyl acetate; orthoester-based solvents such as trimethyl orthoformate, triethyl orthoformate, tri(n-propyl) orthoformate, tri(isopropyl) orthoformate, trimethyl orthoacetate, triethyl orthoacetate, triethyl orthopropionate, trimethyl ortho-n-butyrate, and trimethyl orthoisobutyrate; dimethyl formamide; dimethyl sulfoxide (DMSO); alcohol; and water are exemplary examples.

One kind of the reaction solvent may be used alone, or two or more kinds thereof may be used in combination.

Among these, DMSO is preferable as the reaction solvent.

From the viewpoint of reaction efficiency, the reaction temperature is preferably 10° C. to 80° C., more preferably 15° C. to 60° C., and still more preferably 20° C. to 50° C.

A reaction time is not particularly limited as long as the conversion reaction from the above-described structure represented by Formula (t1-1) to the above-described structure represented by Formula (t2-1) sufficiently proceeds. For example, the reaction time is preferably 0.5 to 48 hours, more preferably 1 to 24 hours, and still more preferably 2 to 12 hours.

After the reaction, the polymer (P2) may be isolated or purified. The polymer (P2) can be isolated or purified by a known method. For isolating or purifying the polymer (P2), for example, concentration, solvent extraction, distillation, crystallization, recrystallization, chromatography, or the like can be appropriately combined and used.

The structure of the polymer (P2) obtained as described above can be identified by general organic analysis methods such as ¹H-nuclear magnetic resonance (NMR) spectroscopy, ¹³C-NMR spectroscopy, ¹⁹F-NMR spectroscopy, infrared (IR) absorption spectroscopy, mass spectrometry (MS), elemental analysis, and X-ray crystal diffraction.

With the production method according to the present embodiment, by using the nucleophilic agent in which the pKa of the conjugate acid is 11 or less, the side reaction in which the thiolactone ring is formed from the thiol group at the terminal of the main chain can be suppressed. Accordingly, it is possible to efficiently obtain the polymer having a thiol group (group represented by Formula (t2-1)) at the terminal of the main chain.

### (Method for Producing Polymer (2))

The method for producing a polymer according to a second embodiment of the present invention includes a step (i) of obtaining the polymer (P2) by the method for producing a polymer according to the first embodiment described above, and a step (ii) of reacting the polymer (P2) with a compound (A1) represented by General Formula (a1-1) to obtain a polymer (P3) having a structure represented by General Formula (t3-1) at a terminal of a main chain.

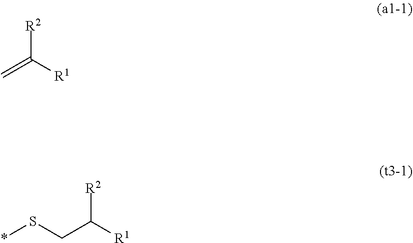

[in the formula, R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit]

<Step (i)>

The step (i) is a step of obtaining the polymer (P2) by the method for producing a polymer according to the first embodiment described above. The step (i) can be performed as described in the first embodiment.

It is preferable that the polymer (P1) used in the step (i) has a constitutional unit derived from (α-substituted) acrylic acid or (α-substituted) acrylic acid ester, the constitutional unit being adjacent to the structure represented by General Formula (t1-1) described above.

It is preferable that the polymer (P2) obtained in the step (i) has a constitutional unit derived from (α-substituted) acrylic acid or (α-substituted) acrylic acid ester, the constitutional unit being adjacent to the structure represented by General Formula (t2-1) described above. The polymer (P2) preferably has a structure represented by General Formula (t2-2).

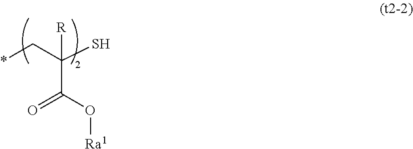

[in the formula, R represents a hydrogen atom, an alkyl group having 1 to 5 carbon atoms, or a halogenated alkyl group having 1 to 5 carbon atoms; Ra¹ represents a hydrogen atom or a monovalent organic group; and * represents a bonding site bonded to a carbon atom which constitutes a main chain of an adjacent constitutional unit]

R and Ra¹ in Formula (t2-2) are the same as R and Ra¹ in Formula (t1-2) described above.

After the step (i), the polymer (P2) may be isolated or purified, but the isolation and purification may not be performed. The polymer (P2) can be isolated or purified by a known method. In the production method according to the present embodiment, after the step (i), the step (ii) can be performed without isolating and purifying the polymer (P2).

<Step (ii)>

The step (ii) is a step of reacting the polymer (P2) with a compound (A1) represented by General Formula (a1-1) to obtain a polymer (P3) having a structure represented by General Formula (t3-1) at a terminal of a main chain.

### <<Compound (A1)>>

The compound (A1) is a compound represented by Formula (a1-1).

In Formula (a1-1), R¹ is a group including a functional group. The functional group included in R¹ is not particularly limited. As the functional group, for example, a vinyl group, an ethynyl group, a carboxy group, a hydroxy group, an amino group, a nitrogen-containing heterocyclic group, a phosphonic acid group, a phosphonic acid ester group, a phosphate group, a phosphate ester group, a carbonyl group, an azide group, a cyano group, a sulfo group, a nitro group, an alkoxy group, an acyl group, a silyl group, and the like are exemplary examples.

In Formula (a1-1), R² represents a hydrogen atom, an alkyl group having 1 to 5 carbon atoms, or a halogenated alkyl group having 1 to 5 carbon atoms.

The alkyl group having 1 to 5 carbon atoms of R² is preferably a linear or branched alkyl group having 1 to 5 carbon atoms. As specific examples thereof, a methyl group, an ethyl group, an n-propyl group, an isopropyl group, an n-butyl group, an isobutyl group, a tert-butyl group, a pentyl group, an isopentyl group, and a neopentyl group are exemplary examples.

The halogenated alkyl group having 1 to 5 carbon atoms of R² is a group obtained by substituting part or all of hydrogen atoms of the above-described alkyl group having 1 to 5 carbon atoms with a halogen atom. As the halogen atom, a fluorine atom, a chlorine atom, a bromine atom, an iodine atom, and the like are exemplary examples, and a fluorine atom is preferable.

R² is more preferably a hydrogen atom or an alkyl group having 1 to 5 carbon atoms, and still more preferably a hydrogen atom or a methyl group.

Specific examples of the compound (A1) are shown below, but the present invention is not limited thereto.

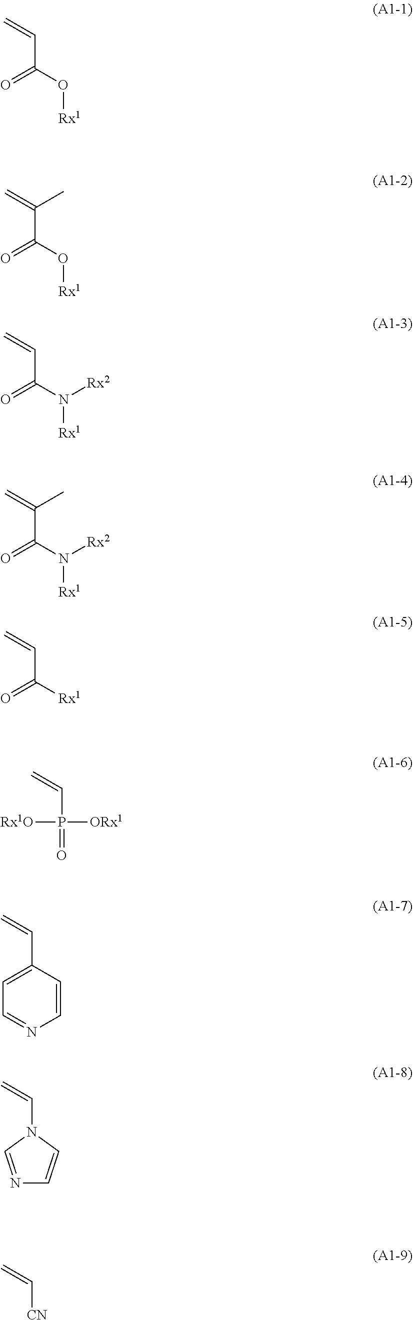

[in the formulae, Rx¹ and Rx² each independently represent a hydrogen atom, an alkyl group which may have a substituent, or an aryl group which may have a substituent]

The alkyl group of Rx¹ and Rx² in Formulae (A1-1) to (A1-6) may be a linear alkyl group, a branched alkyl group, or a cyclic alkyl group.

The linear alkyl group preferably has 1 to 10 carbon atoms, more preferably has 1 to 6 carbon atoms, still more preferably has 1 to 3 carbon atoms, and particularly preferably has 1 or 2 carbon atoms.

The branched alkyl group preferably has 3 to 10 carbon atoms, more preferably has 3 to 6 carbon atoms, still more preferably has 3 or 4 carbon atoms, and particularly preferably has 3 carbon atoms.

The cyclic alkyl group may be monocyclic or polycyclic. As the monocyclic cyclic alkyl group, a group formed by removing one or more hydrogen atoms from a monocycloalkane is preferable. The monocycloalkane preferably has 3 to 6 carbon atoms. As specific examples of the monocycloalkane, cyclopentane, cyclohexane, and the like are exemplary examples. As the polycyclic cyclic alkyl group, a group formed by removing one or more hydrogen atoms from a polycycloalkane is preferable, and the polycycloalkane preferably has 7 to 30 carbon atoms. As specific examples of the polycycloalkane, polycycloalkanes having a bridged ring-based polycyclic skeleton, such as adamantane, norbornane, isobornane, tricyclodecane, and tetracyclododecane, are exemplary examples.

The alkyl group of Rx¹ and Rx² may or may not have a substituent. As the substituent of the alkyl group of Rx¹ and Rx², a carboxy group, a hydroxy group, an amino group, a phosphonic acid ester group, a phosphate group, a phosphate ester group, a carbonyl group, an azide group, a cyano group, a sulfo group, a nitro group, an alkoxy group, an acyl group, a halogen atom, and the like are exemplary examples.

The aryl group of Rx¹ and Rx² in Formulae (A1-1) to (A1-6) may be monocyclic or polycyclic. As the aryl group, a phenyl group, a naphthyl group, a fluorenyl group, an anthracenyl group, a phenanthrenyl group, and the like are exemplary examples.

The aryl group of Rx¹ and Rx² may or may not have a substituent. As the substituent of the aryl group of Rx¹ and Rx², a carboxy group, a hydroxy group, an amino group, a phosphonic acid ester group, a phosphate group, a phosphate ester group, a carbonyl group, an azide group, a cyano group, a sulfo group, a nitro group, an alkoxy group, an acyl group, a halogen atom, an alkyl group, and the like are exemplary examples.

As specific examples of the compound (A1), diethylvinylphosphonic acid, 4-vinylpyridine, 1-vinylimidazole, 2-hydroxyethyl methacrylate, and the like are exemplary examples, but the present invention is not limited thereto.

The reaction solvent in the step (ii) is not particularly limited, and the same reaction solvent as in the step (i) can be used.

The step (ii) can be started by adding the compound (A1) to the reaction solution after the step (i). Accordingly, the step (ii) can be performed in the same reaction container as that of the step (i).

From the viewpoint of reaction efficiency, the reaction temperature is preferably 10° C. to 80° C., more preferably 15° C. to 60° C., and still more preferably 20° C. to 50° C.

A reaction time is not particularly limited as long as the conversion reaction from the above-described structure represented by Formula (t1-1) to the above-described structure represented by Formula (t2-1) sufficiently proceeds. For example, the reaction time is preferably 0.5 to 48 hours, more preferably 1 to 24 hours, and still more preferably 2 to 12 hours.

Through the step (ii), the polymer (P3) having the structure represented by General Formula (t3-1) at the terminal of the main chain can be obtained. R¹ and R² in General Formula (t3-1) are each the same as R¹ and R² in General Formula (a1-1) described above.

It is preferable that the polymer (P3) has a constitutional unit derived from (α-substituted) acrylic acid or (α-substituted) acrylic acid ester, the constitutional unit being adjacent to the structure represented by General Formula (t3-1) described above. The polymer (P3) preferably has a structure represented by General Formula (t3-2) at the terminal of the main chain.

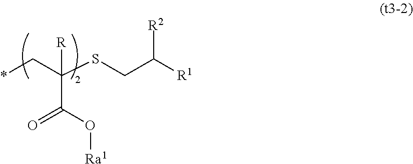

[in the formula, R represents a hydrogen atom, an alkyl group having 1 to 5 carbon atoms, or a halogenated alkyl group having 1 to 5 carbon atoms; Ra¹ represents a hydrogen atom or a monovalent organic group; R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit]

R and Ra¹ in Formula (t3-2) are each the same as R and Ra¹ in Formula (t1-2) described above. R¹ and R² in Formula (t3-2) are each the same as R¹ and R² in Formula (t3-1) described above.

Specific examples of the main chain terminal structure of the polymer (P3) are shown below, but the present invention is not limited thereto.

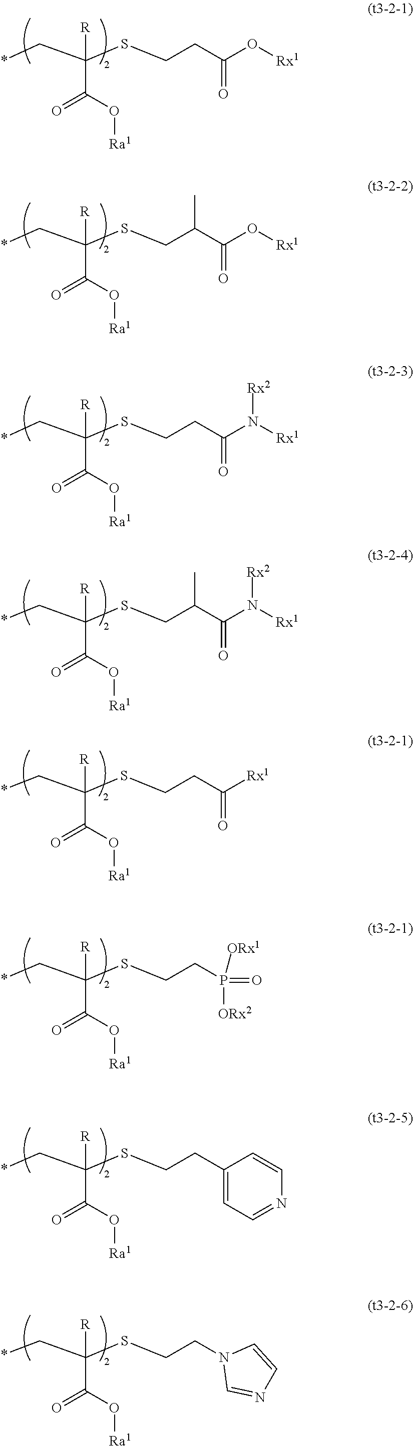

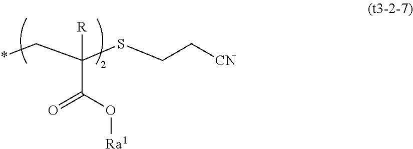

[in the formulae, R and Ra¹ are the same as R and Ra¹ in General Formula (t1-2) described above, Rx¹ and Rx² are each the same as Rx¹ and Rx² in General Formulae (A1-1) to (A1-6) described above, and * represents a bonding site bonded to a carbon atom which constitutes a main chain of an adjacent constitutional unit]

After the step (ii), the polymer (P3) may be isolated or purified. The polymer (P3) can be isolated or purified by a known method. For isolating or purifying the polymer (P3), for example, concentration, solvent extraction, distillation, crystallization, recrystallization, chromatography, or the like can be appropriately combined and used.

The structure of the polymer (P3) obtained as described above can be identified by general organic analysis methods such as ¹H-nuclear magnetic resonance (NMR) spectroscopy, ¹³C-NMR spectroscopy, ¹⁹F-NMR spectroscopy, infrared (IR) absorption spectroscopy, mass spectrometry (MS), elemental analysis, and X-ray crystal diffraction.

In the production method according to the present embodiment, by synthesizing the polymer (P2) by the production method according to the first embodiment described above, the polymer (P2) having a low formation rate of thiolactone rings at the terminal of the main chain can be obtained. Since the compound (A1) is reacted with the polymer (P2) to synthesize the polymer (P3), the efficiency of introducing the compound (A1) into the terminal of the main chain can be enhanced. Therefore, the polymer (P3) in which a functional group is introduced into the terminal of the main chain can be efficiently obtained.

### (Polymer (1))

The polymer according to a third embodiment of the present invention is a polymer having a structure represented by Formula (t2-1) at a terminal of a main chain, in which no peak at 210 ppm is detected in a spectrum measured by ¹³C-NMR in deuterated acetone at 40° C.

*—SH (t2-1)

[* represents a bonding site bonded to a carbon atom which constitutes a main chain of an adjacent constitutional unit]

The polymer according to the present embodiment is the same as the polymer (P2) produced by the production method according to the first embodiment described above. Since the polymer according to the present embodiment has a low content of thiolactone rings at the terminal of the main chain, the polymer according to the present embodiment is characterized in that no peak at 210 ppm is detected in a case where a spectrum measured by ¹³C-NMR in deuterated acetone is obtained at 40° C. The peak at 210 ppm is a peak of the thiolactone ring (Macromolecules 2006, 39, pp. 8616 to 8624). The ¹³C-NMR can be measured, for example, under the following conditions.
Measurement temperature: 40° C.
Sample concentration: 25%
Number of times of integration: 512
Pulse width: 90°
Pulse repetition time: 1 second
Chemical shift value reference: tetramethylsilane
Solvent: acetone-d6

As a measuring device, for example, AVANCE-NEO 5 mm cryoprobe (manufactured by Bruker) can be used.

It is preferable that the polymer according to the present embodiment has a constitutional unit derived from (α-substituted) acrylic acid or (α-substituted) acrylic acid ester, the constitutional unit being adjacent to the structure represented by General Formula (t2-1) described above. The polymer according to the present embodiment preferably has the structure represented by General Formula (t2-2) described above.

The polymer according to the present embodiment may be a composition containing the polymer having the above-described structure represented by Formula (t2-1) at the terminal of the main chain. The composition may be obtained by isolating or purifying a reaction product of the reaction in the production method according to the first embodiment described above. In the composition, a content of a polymer in which the thiolactone ring is formed at the terminal of the main chain is extremely low.

Since the polymer according to the present embodiment has the above-described structure represented by Formula (t2-1) (thiol group) at the terminal of the main chain and has a low content of the thiolactone ring at the terminal of the main chain, the polymer according to the present embodiment is useful as an intermediate for introducing a functional group through the thiol group at the terminal of the main chain.

### (Polymer (2))

The polymer according to a fourth embodiment of the present invention is a polymer having a structure represented by Formula (t3-1) at a terminal of a main chain, in which no peak at 210 ppm is detected in a spectrum measured by ¹³C-NMR in deuterated acetone at 40° C.

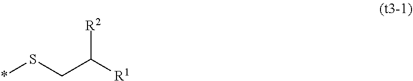

[in the formula, R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit]

The polymer according to the present embodiment is the same as the polymer (P3) produced by the production method according to the first embodiment described above. Since the polymer according to the present embodiment has a low content of thiolactone rings at the terminal of the main chain, the polymer according to the present embodiment is characterized in that no peak at 210 ppm is detected in a case where a spectrum measured by ¹³C-NMR in deuterated acetone is obtained at 40° C. The ¹³C-NMR can be measured under the same conditions as those described in the above-described third aspect.

It is preferable that the polymer according to the present embodiment has a constitutional unit derived from (α-substituted) acrylic acid or (α-substituted) acrylic acid ester, the constitutional unit being adjacent to the structure represented by General Formula (t3-1) described above. The polymer according to the present embodiment preferably has the structure represented by General Formula (t3-2) described above at the terminal of the main chain. As specific examples of the polymer according to the present embodiment, polymers having a structure represented by any one of Formulae (t3-2-1) to (t3-2-7) described above at the terminal of the main chain are exemplary examples.

The polymer according to the present embodiment may be a composition containing the polymer having the above-described structure represented by Formula (t3-1) at the terminal of the main chain. The composition may be obtained by isolating or purifying a reaction product after the step (ii) in the production method according to the second embodiment described above. In the composition, a content of a polymer in which the thiolactone ring is formed at the terminal of the main chain is extremely low.

In the polymer according to the present embodiment, the content of the thiolactone ring at the terminal of the main chain is low, and a functional group is introduced into the terminal of the main chain with high efficiency. Therefore, the polymer according to the present embodiment can be used as a high-quality functional polymer.

### EXAMPLE

Hereinafter, the present invention will be described in more detail with reference to examples, but the present invention is not limited to these examples.

### Example 1

### <Synthesis of Polymer (P1-1)>

0.030 g (0.181 mmol) of azoisobutyronitrile, 7.69 g (76.8 mmol) of methyl methacrylate, 0.20 g (0.90 mmol) of 2-cyano-2-propylbenzodithioate, and 5.0 g of tetrahydrofuran were charged into a 100 mL Schlenk flask, and freeze degassing was performed 5 times with liquid nitrogen to be under an argon atmosphere. The above-described Schlenk flask was returned to room temperature, and the mixture was heated and stirred at 70° C. for 10 hours to perform a polymerization reaction. This polymerization solution was returned to room temperature, diluted with 20.0 g of tetrahydrofuran, and added dropwise to 250 g of methanol. A pale orange solid obtained thus was collected and used as a polymer (P1-1).

### <Synthesis of Polymer (P2-1)>

The polymer (P1-1) was dissolved in 30 g of dimethyl sulfoxide (DMSO), 3.03 g (15.0 mmol) of tri-n-butylphosphine (P(nBu)₃) was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 4.2 g of a white solid. In the following formula, “r.t.” indicates room temperature (the same applies hereinafter).

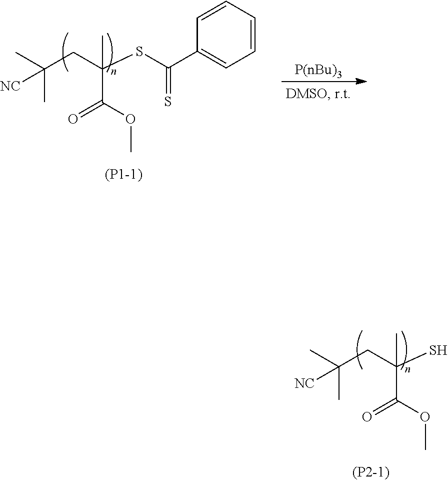

### Example 2

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 3.93 g (15.0 mmol) of triphenylphosphine was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 4.0 g of a white solid.

### Example 3

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 1.86 g (15.0 mmol) of trimethyl phosphite was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 4.2 g of a white solid.

### Example 4

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 1.40 g (15.0 mmol) of 4-methylpyridine was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 4.1 g of a white solid.

### Comparative Example 1

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 0.89 g (15.0 mmol) of propylamine was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 4.0 g of a white solid.

### Comparative Example 2

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 1.49 g (15.0 mmol) of cyclohexylamine was added thereto in an argon atmosphere, and a cleavage reaction of the dithiobenzoate terminal was carried out by stirring the mixture at room temperature for 3 hours. Next, the reaction solution was added dropwise to 300 g of methanol to obtain 3.9 g of a white solid.

### Example 5

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 3.03 g (15.0 mmol) of tributylphosphine was added thereto in an argon atmosphere, and a cleavage reaction of the dithiobenzoate terminal was carried out by stirring the mixture at room temperature for 3 hours.

### <Synthesis of Polymer (P3-1)>

6.16 g (37.5 mmol) of diethyl vinyl phosphonic acid was added to the reaction solution obtained in <Synthesis of Polymer (P2-1)>, and the mixture was further stirred at room temperature for 3 hours. The obtained reaction solution was added dropwise to 300 g of methanol to obtain 4.1 g of a white solid. In the following formula, Et indicates an ethyl group.

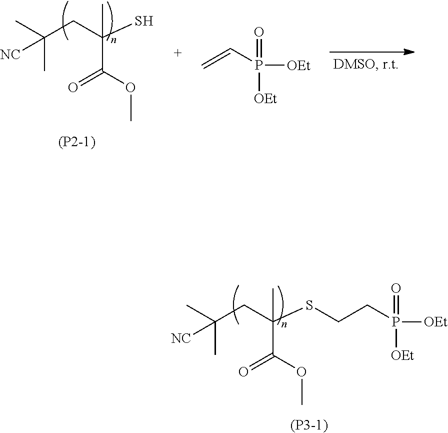

### Example 6

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of DMSO, 3.03 g (15.0 mmol) of tributylphosphine was added thereto in an argon atmosphere, and a cleavage reaction of the dithiobenzoate terminal was carried out by stirring the mixture at room temperature for 3 hours.

### <Synthesis of Polymer (P3-2)>

3.94 g (37.5 mmol) of 4-vinylpyridine was added to the reaction solution obtained in <Synthesis of Polymer (P2-1)>, and the mixture was further stirred at room temperature for 3 hours. The obtained reaction solution was added dropwise to 300 g of methanol to obtain 3.7 g of a white solid.

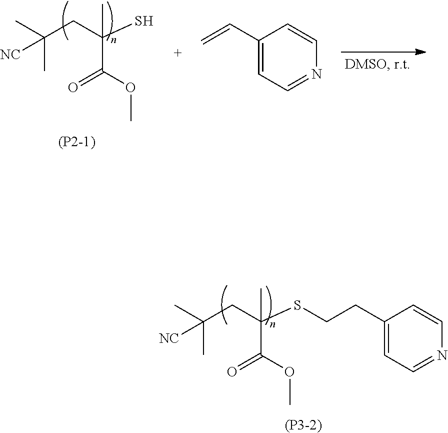

### Example 7

### <Synthesis of Polymer (P1-2)>

0.030 g (0.181 mmol) of azoisobutyronitrile, 10.00 g (76.8 mmol) of 2-hydroxyethyl methacrylate, 0.20 g (0.90 mmol) of 2-cyano-2-propylbenzodithioate, and 5.0 g of tetrahydrofuran were charged into a 100 mL Schlenk flask, and freeze degassing was performed 5 times with liquid nitrogen to be under an argon atmosphere. The above-described Schlenk flask was returned to room temperature, and the mixture was heated and stirred at 70° C. for 10 hours to perform a polymerization reaction. This polymerization solution was returned to room temperature, diluted with 20.0 g of tetrahydrofuran, and added dropwise to 250 g of methanol. A pale orange solid obtained thus was collected and used as a polymer (P1-2).

### <Synthesis of Polymer (P2-2)>

The polymer (P1-2) was dissolved in 30 g of DMSO, 3.03 g (15.0 mmol) of tributylphosphine was added thereto in an argon atmosphere, and a cleavage reaction of the dithiobenzoate terminal was carried out by stirring the mixture at room temperature for 3 hours.

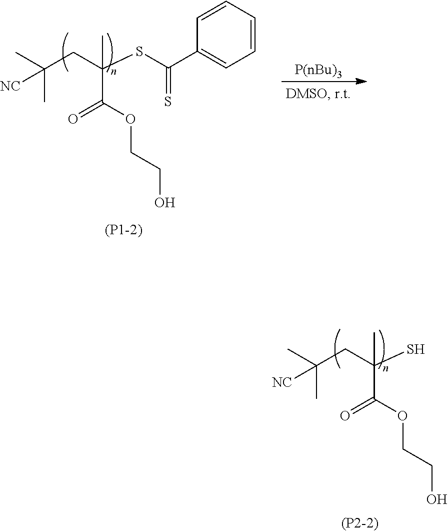

### <Synthesis of Polymer (P3-3)>

3.53 g (37.5 mmol) of 1-vinylimidazole was added to the reaction solution obtained in <Synthesis of Polymer (P2-2)>, and the mixture was further stirred at room temperature for 3 hours. The obtained reaction solution was added dropwise to 300 g of methanol to obtain 3.9 g of a white solid.

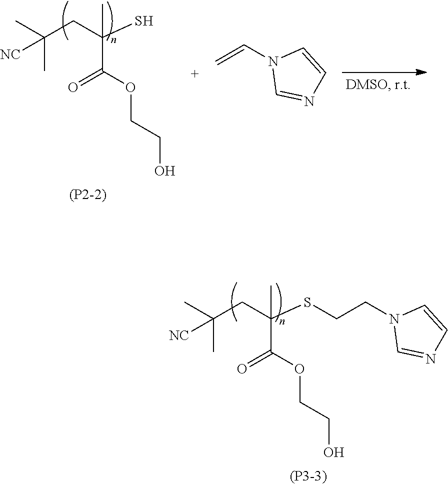

### Example 8

### <Synthesis of Polymer (P1-3)>

0.030 g (0.181 mmol) of azoisobutyronitrile, 5.41 g (54.0 mmol) of methyl methacrylate, 2.87 g (27.6 mmol) of styrene, 0.20 g (0.90 mmol) of 2-cyano-2-propylbenzodithioate, and 5.0 g of tetrahydrofuran were charged into a 100 mL Schlenk flask, and freeze degassing was performed 5 times with liquid nitrogen to be under an argon atmosphere. The above-described Schlenk flask was returned to room temperature, and the mixture was heated and stirred at 70° C. for 10 hours to perform a polymerization reaction. This polymerization solution was returned to room temperature, diluted with 20.0 g of tetrahydrofuran, and added dropwise to 250 g of methanol. A pale orange solid obtained thus was collected and used as a polymer (P1-3).

### <Synthesis of Polymer (P2-3)>

The polymer (P1-3) was dissolved in 30 g of DMSO, 3.03 g (15.0 mmol) of tributylphosphine was added thereto in an argon atmosphere, and a cleavage reaction of the dithiobenzoate terminal was carried out by stirring the mixture at room temperature for 3 hours.

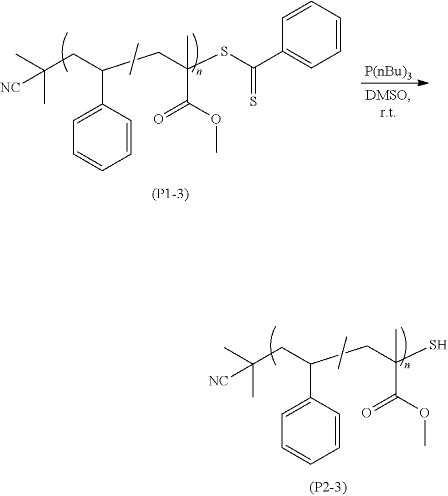

### <Synthesis of Polymer (P3-4)>

4.88 g (37.5 mmol) of 2-hydroxyethyl methacrylate was added to the reaction solution obtained in <Synthesis of Polymer (P2-3)>, and the mixture was further stirred at room temperature for 3 hours. The obtained reaction solution was added dropwise to 300 g of methanol to obtain 3.8 g of a white solid.

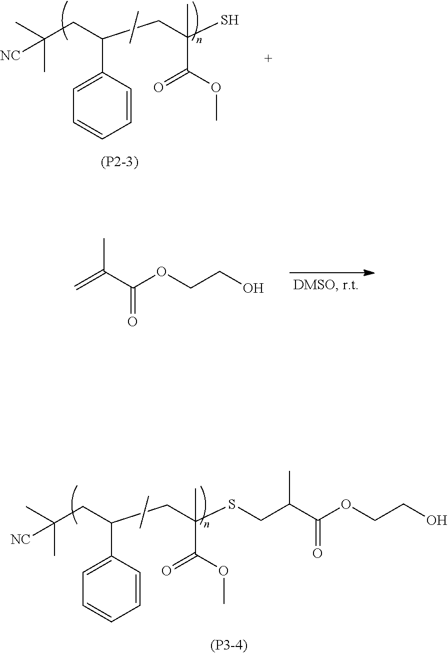

### Comparative Example 3

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of dimethyl sulfoxide, 1.49 g (15.0 mmol) of cyclohexylamine was added thereto in an argon atmosphere, and a cleavage reaction of the dithiobenzoate terminal was carried out by stirring the mixture at room temperature for 3 hours.

### <Synthesis of Polymer (P3-1)>

6.16 g (37.5 mmol) of diethyl vinyl phosphonic acid was added to the reaction solution obtained in <Synthesis of Polymer (P2-1)>, and the mixture was further stirred at room temperature for 3 hours. The obtained reaction solution was added dropwise to 300 g of methanol to obtain 3.7 g of a white solid.

### Comparative Example 4

### <Synthesis of Polymer (P1-1)>

A polymer (P1-1) was synthesized in the same manner as in Example 1.

### <Synthesis of Polymer (P2-1)>

The polymer (P1-1) was dissolved in 30 g of dimethyl sulfoxide, 1.49 g (15.0 mmol) of cyclohexylamine was added thereto in an argon atmosphere, and a cleavage reaction of the dithiobenzoate terminal was carried out by stirring the mixture at room temperature for 3 hours.

### <Synthesis of Polymer (P3-2)>

3.94 g (37.5 mmol) of 4-vinylpyridine was added to the reaction solution obtained in <Synthesis of Polymer (P2-1)>, and the mixture was further stirred at room temperature for 3 hours. The obtained reaction solution was added dropwise to 300 g of methanol to obtain 3.5 g of a white solid.

### Comparative Example 5

### <Synthesis of Polymer (P1-2)>

A polymer (P1-2) was synthesized in the same manner as in Example 7.

### <Synthesis of Polymer (P2-2)>

The polymer (P1-2) was dissolved in 30 g of dimethyl sulfoxide, 1.49 g (15.0 mmol) of cyclohexylamine was added thereto in an argon atmosphere, and a cleavage reaction of the dithiobenzoate terminal was carried out by stirring the mixture at room temperature for 3 hours.

### <Synthesis of Polymer (P3-3)>

3.53 g (37.5 mmol) of 1-vinylimidazole was added to the reaction solution obtained in <Synthesis of Polymer (P2-2)>, and the mixture was further stirred at room temperature for 3 hours. The obtained reaction solution was added dropwise to 300 g of methanol to obtain 3.6 g of a white solid.

### Comparative Example 6

### <Synthesis of Polymer (P1-3)>

A polymer (P1-3) was synthesized in the same manner as in Example 8.

### <Synthesis of Polymer (P2-3)>

The polymer (P1-3) was dissolved in 30 g of dimethyl sulfoxide, 1.49 g (15.0 mmol) of cyclohexylamine was added thereto in an argon atmosphere, and a cleavage reaction of the dithiobenzoate terminal was carried out by stirring the mixture at room temperature for 3 hours.

### <Synthesis of Polymer (P3-3)>

4.88 g (37.5 mmol) of 2-hydroxyethyl methacrylate was added to the reaction solution obtained in <Synthesis of Polymer (P2-3)>, and the mixture was further stirred at room temperature for 3 hours. The obtained reaction solution was added dropwise to 300 g of methanol to obtain 3.8 g of a white solid.

[Acid Dissociation Constant (pKa)]

### <<pKa of Conjugate Acid of Nucleophilic Agent>>

An acid dissociation constant (pKa) of a conjugate acid of each nucleophilic agent used in Examples 1 to 8 and Comparative Examples 1 to 6 in dimethyl sulfoxide (DMSO) was calculated using thermodynamic property estimation software “BIOVIA COSMOtherm 2021” (manufactured by MOLSIS Inc.). BP_TZVPD_FINE_21 was used as a parameter. The most stable structure of the molecule used for the calculation was calculated with “Turbomole 7.5.1” (manufactured by MOLSIS Inc.) and “BIOVIA COSMOconf 2021” (manufactured by MOLSIS Inc.). The results are shown in Table 1.

### <<pKa of Thiol Group at Terminal of Main Chain of Polymer>>

In order to obtain a pKa of a thiol group at the terminal of the main chain included in the polymer (P2), a structure represented by Formula (s1) was set as a simplified structure. The pKa of the thiol group of the structure represented by Formula (s1) in DMSO was calculated by the same method as that in <<pKa of conjugate acid of nucleophilic agent>> described above. The results are shown in Table 2 as “pKa of thiol group at terminal of main chain of polymer”.

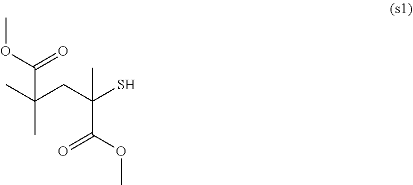

TABLE 2

| | | pKa of conjugate |
|---|---|---|
| | Nucleophilic agent | acid (DMSO) |
| Example 1 | Tri-n-butylphosphine | 10.7 |
| Examples 5 to 8 | | |
| Example 2 | Triphenylphosphine | 5.6 |
| Example 3 | Trimethyl phosphite | 3.6 |
| Example 4 | p-Methylpyridine | 7.5 |
| Comparative | Propylamine | 15.2 |
| Example 1 | | |
| Comparative | Cyclohexylamine | 15.3 |
| Examples 2 to 6 | | |

| | |
|---|---|
| pKa of thiol group at terminal | 11.1 |
| of main chain of polymer (DMSO) | |

### [Evaluation of Thiolactone Ring Formation]

It was reported that the thiolactone ring was detected as a peak at 210 ppm in a ¹³C-NMR spectrum (Macromolecules 2006, 39, pp. 8616 to 8624). The white solid obtained in each example was subjected to the ¹³C-NMR measurement, and a formation of the thiolactone ring was evaluated by confirming the peak at 210 ppm in the ¹³C-NMR spectrum.
Measurement conditions for the ¹³C-NMR are shown below.
Device: AVANCE-NEO 5 mm cryoprobe manufactured by Bruker
Measurement temperature: 40° C.
Sample concentration: 25%
Number of times of integration: 512
Pulse width: 90°
Pulse repetition time: 1 second
Chemical shift value reference: tetramethylsilane
Solvent: acetone-d6

Evaluation was performed based on the following evaluation standard, and the results are shown in Table 3 as “Formation of thiolactone ring”.

Evaluation standard
A: peak at 210 ppm was not detected.
B: peak at 210 ppm was detected.

### [Evaluation of Terminal Conversion Rate]

With regard to the white solid obtained in Examples 5 to 8 and Comparative Examples 3 to 6, a proportion (terminal conversion rate) of introduction of a functional group derived from diethylvinylphosphonic acid, 4-vinylpyridine, 1-vinylimidazole, or 2-hydroxyethyl methacrylate into the terminal of the main chain of the polymer was obtained. The terminal conversion rate (%) was calculated from ¹H-NMR measurement data by the following procedure.

Each of the polymers (P1-1) obtained in <Synthesis of Polymer (P1-1)> of Examples 5 to 8 and Comparative Examples 3 to 6 was dissolved in deuterated chloroform, and subjected to the measurement of ¹H-NMR.

Each of the white solids obtained in Examples 5 to 8 and Comparative Examples 3 to 6 was dissolved in deuterated chloroform, and subjected to the measurement of ¹H-NMR.

In each ¹H-NMR spectrum obtained by the above-described measurement, among peaks derived from the main chain portion (polymethyl measurement portion), a range of peaks not including peaks derived from solvents and terminal structures was integrated. The integration range was set to be the same in all ¹H-NMR spectrum data. A coefficient for correcting the integral value of each example to the same value was determined for each example. A peak value of the ¹H-NMR spectrum of each example was normalized using this coefficient.

Next, in the ¹H-NMR spectrum of the polymer (P1-1) of each example after the normalization, an integrated value (x_{A}) of the peak derived from the RAFT agent (2-cyano-2-propylbenzodithioate) was determined. Similarly, in the ¹H-NMR spectrum of each example after the normalization, an integrated value (x_{B}) of the peak derived from the functional group introduced at the terminal of the main chain was determined.

From the values of x_{A} and x_{B}, the terminal conversion rate was calculated by the following expression (1). The results are shown in Table 3 as “Terminal conversion rate”.

Terminal conversion rate (%)={(x_{B}/H_{B})/(x_{A}/H_{A})}×100 (1)

TABLE 3

| | | | | Terminal |
|---|---|---|---|---|
| | | | Formation of | conversion |
| | | Final | thiolactone | rate |
| | Nucleophilic agent | product | ring | (%) |
| Example 1 | Tri-n-butylphosphine | P2-1 | A | — |
| Example 2 | Triphenylphosphine | P2-1 | A | — |
| Example 3 | Trimethyl phosphite | P2-1 | A | — |
| Example 4 | p-Methylpyridine | P2-1 | A | — |
| Comparative | Propylamine | P2-1 | B | — |
| Example 1 | | | | |
| Comparative | Cyclohexylamine | P2-1 | B | — |
| Example 2 | | | | |
| Example 5 | Tri-n-butylphosphine | P3-1 | A | 70 |
| Example 6 | Tri-n-butylphosphine | P3-2 | A | 65 |
| Example 7 | Tri-n-butylphosphine | P3-3 | A | 67 |
| Example 8 | Tri-n-butylphosphine | P3-4 | A | 70 |
| Comparative | Cyclohexylamine | P3-1 | B | 53 |
| Example 3 | | | | |
| Comparative | Cyclohexylamine | P3-2 | B | 45 |
| Example 4 | | | | |
| Comparative | Cyclohexylamine | P3-3 | B | 46 |
| Example 5 | | | | |
| Comparative | Cyclohexylamine | P3-4 | B | 51 |
| Example 6 | | | | |

As shown in Table 3, in Examples 1 to 8, the formation of the thiolactone ring could not be confirmed. On the other hand, in Comparative Examples 1 to 6, the formation of the thiolactone ring was confirmed.

It was confirmed that the terminal conversion rate was improved in Examples 5 to 8 as compared with Comparative Examples 3 to 6.

From these results, it was confirmed that, by cleaving the dithiobenzoate terminal using the nucleophilic agent in which the pKa of the conjugate acid was 11 or less, the formation of the thiolactone ring was suppressed and the efficiency of introduction of a functional group to the terminal of the main chain was improved.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A method for producing a polymer, comprising:
reacting a polymer (P1) having a structure represented by General Formula (t1-1) at a terminal of a main chain with a nucleophilic agent in which a pKa of a conjugate acid is 11 or less to obtain a polymer (P2) having a structure represented by Formula (t2-1) at a terminal of a main chain, 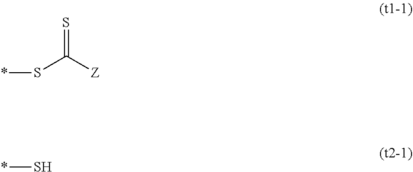
wherein, in General Formula (t1-1), Z represents a monovalent organic group; and * represents a bonding site bonded to a carbon atom which constitutes a main chain of an adjacent constitutional unit,
and in General Formula (t2-1), * represents a bonding site bonded to a carbon atom which constitutes a main chain of an adjacent constitutional unit.

2. A method for producing a polymer, comprising:
(i) obtaining the polymer (P2) by the method for producing a polymer according to claim 1; and
(ii) reacting the polymer (P2) with a compound (A1) represented by General Formula (a1-1) to obtain a polymer (P3) having a structure represented by General Formula (t3-1) at a terminal of a main chain, 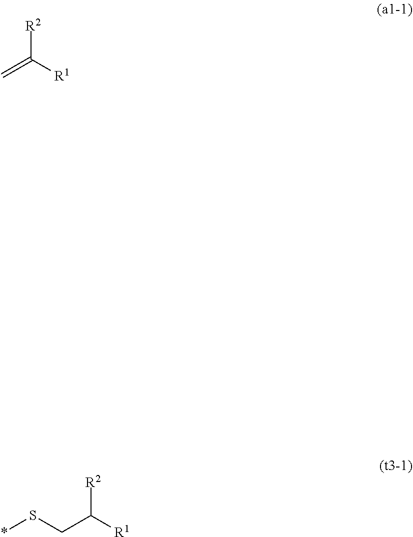
wherein R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit.

3. The method for producing a polymer according to claim 2, wherein (i) and (ii) are carried out in the same reaction container.

4. The method for producing a polymer according to claim 1, wherein the polymer (P1) has a constitutional unit derived from an (α-substituted) acrylic acid or an (α-substituted) acrylic acid ester, wherein the constitutional unit is adjacent to the structure represented by General Formula (t1-1).

5. The method for producing a polymer according to claim 1, wherein the nucleophilic agent is at least one selected from the group consisting of a tertiary phosphine, a pyridine, an alkylpyridine, an aniline, and a phosphorous acid ester.

6. A polymer having a structure represented by Formula (t2-1) at a terminal of a main chain,
wherein no peak at 210 ppm is detected in a spectrum measured by ¹³C-NMR in deuterated acetone at 40° C.,
*—SH (t2-1)
and wherein * represents a bonding site bonded to a carbon atom which constitutes a main chain of an adjacent constitutional unit.

7. The polymer according to claim 6, wherein the polymer has a constitutional unit derived from an (α-substituted) acrylic acid or an (α-substituted) acrylic acid ester, wherein the constitutional unit is adjacent to the structure represented by General Formula (t2-1).

8. A polymer having a structure represented by Formula (t3-1) at a terminal of a main chain,
wherein no peak at 210 ppm is detected in a spectrum measured by ¹³C-NMR in deuterated acetone at 40° C., 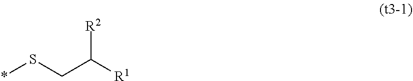
and wherein R¹ represents a group including a functional group; R² represents a hydrogen atom, an alkyl group having 1 to 5 carbon atoms, or a halogenated alkyl group having 1 to 5 carbon atoms; and * represents a bonding site bonded to a carbon atom which constitutes a main chain of an adjacent constitutional unit.

9. The polymer according to claim 8, wherein the polymer has a constitutional unit derived from an (α-substituted) acrylic acid or an (α-substituted) acrylic acid ester, wherein the constitutional unit is adjacent to the structure represented by General Formula (t3-1).
